(19) United States
(12) Patent Application Publication
(10) Pub. No.: US 2026/0320096 A1
(43) Pub. Date: Oct. 15, 2026

(54) CONTENT MODELING AND STRUCTURED OUTPUT GENERATION

(71) Applicant: NVIDIA Corporation, Santa Clara, CA (US)

(72) Inventors: Aditi BODHANKAR, Sunnyvale, CA (US); Shashank VERMA, Milpitas, CA (US); Davide ONOFRIO, San Francisco, CA (US); Annie Prasanna SURLA, San Jose, CA (US); Tanay VARSHNEY, San Jose, CA (US)

(73) Assignee: NVIDIA Corporation, Santa Clara, CA (US)

(21) Appl. No.: 19/179,103

(22) Filed: Apr. 15, 2025

(51) Int. Cl. G06F 16/334; G06F 16/335; G06F 16/34; G06F 16/353

(52) U.S. Cl. CPC G06F 16/334; G06F 16/335; G06F 16/345; G06F 16/353

(57) ABSTRACT

Various examples, systems, and methods are disclosed relating to a content curation pipeline. A first computing system obtain, from at least one data source, a plurality of content records corresponding with at least one content source of the at least one data source. The first computing system determine a subset of a plurality of embeddings corresponding to at least one category. The first computing system apply the subset of the plurality of embeddings as input to at least one language model (LM) to cause the at least one LM to generate, using a template, at least one structured output comprising a plurality of modified content and corresponding metadata. The first computing system provide, via an interface, the at least one structured output.

### BACKGROUND

Generating data outputs of information sources from data streams presents challenges. Some existing systems rely on partially automated workflows, requiring manual intervention for tasks such as data retrieval, summarization, or organization. These systems often produce outputs focused on individual topics or provide generalized summaries of larger data collections, resulting in limited adaptability and incomplete coverage of evolving trends across multiple categories. Many existing solutions are inadequate for delivering data outputs that dynamically adapt to user preferences and/or provide analysis of trends across diverse categories, instead relying on static datasets or infrequent updates. These limitations affect the ability of systems to deliver timely and/or relevant outputs that align with dynamic user requirements and/or reflect ongoing advancements in areas of interest.

### SUMMARY

Implementations of the present disclosure relate to systems and methods for obtaining, processing, and/or generating structured outputs from content records (assets, etc.) sourced from at least one data source (e.g., social media platforms, blogs, research repositories, and/or news feeds having content sources corresponding to accounts, identifiers, user profiles, and/or any user-generated content). These implementations can involve generating embeddings for content analysis, and/or utilizing language models to generate modified content (e.g., summarized and headline content). For example, systems and methods in accordance with the present disclosure can determine subsets of embeddings based on rankings corresponding to at least one category (e.g., security, artificial intelligence, agents, customization), and apply the subsets to language models to generate structured outputs (e.g., summaries, headlines, trend analyses, user-specific recommendations, and/or any reports). The structured outputs can be generated based on templates (e.g., predefined schemas or layouts for content organization) and provided through interfaces (e.g., email, web dashboards, APIs) for user interaction. The systems and methods can facilitate the processing and categorization of diverse content records, improve the generation of structured outputs, and support applications using category-based organization and summarization of content.

Some implementations relate to a system. The system including one or more processors to obtain, from at least one data source, a plurality of content records corresponding with at least one content source of the at least one data source. The system including one or more processors to determine a subset of a plurality of embeddings corresponding to at least one category. In some implementations, determining the subset of the plurality of embeddings is based at least on a ranking of the plurality of embeddings organized according to the at least one category. The system including one or more processors to apply the subset of the plurality of embeddings as input to at least one language model (LM) to cause the at least one LM to generate a plurality of modified content and corresponding metadata. The system including one or more processors to generate, using the plurality of modified content and the corresponding metadata, at least one output based at least on a template. The system including one or more processors to provide, via an interface, the at least one output.

In some implementations, the one or more processors are to generate, using at least one second LM, the template based at least on at least one schema or at least one structure parameter corresponding with organizing the plurality of modified content and the corresponding metadata. In some implementations, the one or more processors are to update the plurality of content records based at least on at least one of a similarity threshold between at least two of the plurality of content records or identifying attributes in the plurality of content records. In some implementations, the one or more processors are to generate, using the plurality of embeddings corresponding with the plurality of content records and a plurality of structured outputs, a plurality of clusters based on at least one similarity metric. In some implementations, the one or more processors are to apply the plurality of clusters as input to at least one third LM to cause the at least one third LM to generate at least one cluster representation.

In some implementations, the one or more processors are to obtain additional content corresponding to the at least one cluster representation based on interfacing with a plurality of data sources. In some implementations, the one or more processors are update the at least one cluster representation corresponding to at least one trend identified in the additional content. In some implementations, the one or more processors are update a ranking function based on the at least one updated cluster representation, the ranking function used in the ranking of the plurality of embeddings. In some implementations, the one or more processors are update the at least one output based at least on the at least one updated cluster representation. In some implementations, updating the at least one output includes at least one of incorporating at least one summary of the additional content into the at least one output or updating the corresponding metadata.

In some implementations, the one or more processors are to generate, using a curation model, the plurality of embeddings of at least one segment of the plurality of content records based on at least one of at least one textual element, at least one contextual attribute, or metadata of the plurality of content records. In some implementations, the one or more processors are to receive, from a user device, a query corresponding to at least one of a plurality of outputs. In some implementations, the one or more processors are to generate an embedding of the query. In some implementations, the one or more processors are to determine, based at least on the embedding, a filtered subset of the plurality of embeddings. In some implementations, the one or more processors are to apply the filtered subset of the plurality of embeddings as input to the at least one LM to cause the at least one LM to generate a response to the query. In some implementations, the one or more processors are to provide, to the user device, the response to the query.

In some implementations, the one or more processors are to obtain a conversation cache and historical conversation data based at least on interfacing with a plurality of data sources. In some implementations, the one or more processors are to generate, using the conversation cache and the historical conversation data, a plurality of clusters based at least on a preference similarity metric. In some implementations, the one or more processors are to apply the plurality of clusters as input to at least one fourth LM to cause the at least one fourth LM to generate at least one cluster representation. In some implementations, the one or more processors are to update a ranking function based on the at least one cluster representation, the ranking function used in the ranking of the plurality of embeddings.

In some implementations, the at least one content source corresponds to a set of identifiers of at least one data source identified based at least on user activity data or a similarity metric to the at least one category. In some implementations, determining the subset of a plurality of embeddings is based on at least on using a fifth LM to process a plurality of relationships between the plurality of embeddings and the at least one category. In some implementations, the system includes an agent computing system to obtain and model structured and unstructured data. In some implementations, the at least one data source includes a first data source accessed via a first data channel and a second data source accessed via a second data channel.

Some implementations relate to one or more processors including processing circuitry to obtain, from at least one data source, a plurality of content assets corresponding with the at least one data source. The processing circuitry is to determine a subset of a plurality of embeddings corresponding to at least one category. In some implementations, determining the subset of the plurality of embeddings is based at least on a ranking of the plurality of embeddings organized according to the at least one category. The processing circuitry is to apply the subset of the plurality of embeddings as input to at least one language model (LM) to cause the at least one LM to generate, using a template, at least one output including a plurality of modified content and corresponding metadata. The processing circuitry is to provide, via an interface, the at least one output.

In some implementations, the processing circuitry is to generate, using at least one second LM, the template based at least on at least one schema or at least one structure parameter corresponding with organizing the plurality of modified content and the corresponding metadata. In some implementations, the processing circuitry is to update the plurality of content assets based at least on at least one of a similarity threshold between at least two of the plurality of content assets or identifying attributes in the plurality of content assets. In some implementations, the processing circuitry is to obtain the plurality of embeddings corresponding with the plurality of content assets and a plurality of structure outputs. In some implementations, the processing circuitry is to generate, using the plurality of embeddings, a plurality of clusters based on at least one similarity metric. In some implementations, the processing circuitry is to apply the plurality of clusters as input to at least one third LM to cause the at least one third LM to generate at least one cluster representation.

In some implementations, the processing circuitry is to obtain additional content corresponding to the at least one cluster representation based on interfacing with a plurality of data sources. In some implementations, the processing circuitry is to update the at least one cluster representation corresponding to at least one trend identified in the additional content. In some implementations, the processing circuitry is to update a ranking function based on the at least one updated cluster representation, the ranking function used in the ranking of the plurality of embeddings. In some implementations, the processing circuitry is to update the at least one output based at least on the at least one updated cluster representation. In some implementations, updating the at least one output includes at least one of incorporating at least one summary of the additional content into the at least one output or updating the corresponding metadata. In some implementations, the processing circuitry is to generate, using a curation model, the plurality of embeddings of at least one segment of the plurality of content assets based on at least one of at least one textual element, at least one contextual attribute, or metadata of the plurality of content assets.

In some implementations, the processing circuitry is to receive, from a user device, a query corresponding to at least one of a plurality of outputs. In some implementations, the processing circuitry is to generate an embedding of the query. In some implementations, the processing circuitry is to determine, based at least on the embedding, a filtered subset of the plurality of embeddings. In some implementations, the processing circuitry is to apply the filtered subset of the plurality of embeddings as input to the at least one LM to cause the at least one LM to generate a response to the query. In some implementations, the processing circuitry is to provide, to the user device, the response to the query.

In some implementations, the processing circuitry is to obtain a conversation cache and historical conversation data based on interfacing with a plurality of data sources. In some implementations, the processing circuitry is to generate, using the conversation cache and the historical conversation data, a plurality of clusters based at least on a preference similarity metric. In some implementations, the processing circuitry is to apply the plurality of clusters as input to at least one fourth LM to cause the at least one fourth LM to generate at least one cluster representation. In some implementations, the processing circuitry is to update a ranking function based on the at least one cluster representation, the ranking function used in the ranking of the plurality of embeddings.

Some implementations relate to a method. The method includes identifying, by one or more processors from at least one data source, a plurality of content corresponding with the at least one data source. The method includes determining, by the one or more processors, a subset of a plurality of embeddings corresponding to at least one category. The method includes generating, by the one or more processors using at least one language model (LM), at least one output including a plurality of modified content and corresponding metadata, the at least one output generated based at least on the subset of the plurality of embeddings. The method includes causing, using the one or more processors, presentation of the at least one output.

In some implementations, the system is included in at least one of a system for generating one or more structured outputs, a system for aggregating or summarizing one or more content records based on one or more categories or one or more trends, a system for selecting one or more content records for presentation, a system for generating one or more personalized outputs, a system implementing one or more multi-model language models, a system implementing one or more large language models (LLMs), a system implementing one or more small language models (SLMs), a system implementing one or more vision language models (VLMs), a system for generating synthetic data, a system for generating synthetic data using AI, a control system for an autonomous or semi-autonomous machine, a perception system for an autonomous or semi-autonomous machine, a system for performing digital twin operations, a system for performing light transport simulation, a system for performing remote operations, a system implemented using an edge device, a system implemented using a robot, a system for performing conversational AI operations, a system incorporating one or more virtual machines (VMs), a system for using or deploying one or more inference microservices, a system for presenting at least one of virtual reality content, augmented reality content, or mixed reality content, a system implemented at least partially in a data center, or a system implemented at least partially using cloud computing resources.

### BRIEF DESCRIPTION OF THE DRAWINGS

The present systems and methods for content modeling and output generation are described in detail below with reference to the attached drawing figures, wherein:

FIG. 1 is a block diagram of an example of a system, in accordance with some implementations of the present disclosure;

FIG. 2 is a flow diagram of an example of a method for content modeling and output generation in a content curation pipeline, in accordance with some implementations of the present disclosure;

FIGS. 3A-3D depict example illustrations of content modeling and output generation in a content curation pipeline, in accordance with some implementations of the present disclosure;

FIG. 4 depicts an example interface corresponding to an output, in accordance with some implementations of the present disclosure;

FIG. 5A is a block diagram of an example generative language model system suitable for use in implementing at least some implementations of the present disclosure;

FIG. 5B is a block diagram of an example generative language model that includes a transformer encoder-decoder suitable for use in implementing at least some implementations of the present disclosure;

FIG. 5C is a block diagram of an example generative language model that includes a decoder-only transformer architecture suitable for use in implementing at least some implementations of the present disclosure;

FIG. 6 is a block diagram of an example computing device suitable for use in implementing at least some implementations of the present disclosure;

FIG. 7 is a block diagram of an example data center suitable for use in implementing at least some implementations of the present disclosure.

### DETAILED DESCRIPTION

This disclosure relates to systems and methods for content modeling and structured output generation based on content records obtained from at least one data source. For example, systems and methods in accordance with the present disclosure facilitate the categorization of content records, generate embeddings for content analysis, and apply language models to generate modified content (e.g., summarized and headline content). The structured outputs generated can be presented according to templates and provided through various interfaces. The systems can facilitate the ranking and customization of content records to meet specific categories of interest.

Some techniques for generating structured outputs fail to incorporate categorization, trend detection, and/or user-specific customization. These methods often rely on static pipelines (e.g., fixed configurations, predefined content categories) and generalized processing (e.g., non-dynamic summaries, surface-level content analysis), resulting in incomplete or redundant content that does not address changing content or trends. Additionally, traditional systems often lack the capability to dynamically retrieve, rank, and/or organize content records from diverse data sources and/or content sources, such as social media platforms, research repositories, news feeds, blogs, and/or accounts. This can lead to inefficiencies in content delivery, reducing the relevance and usability of structured outputs. The technical limitations relate to how these systems process dynamic ranking, multi-source and/or multi-content-source data integration, and/or template-based structuring. For example, inadequate ranking mechanisms can result in irrelevant and/or redundant content being included in structured outputs, while poor template configurations can prevent effective organization of the summarized content. The improved embodiments described herein rank content records, categorize them into groupings, and/or generate structured outputs that align with user-defined and/or detected categories.

Systems and methods in accordance with the present disclosure provide improved categorization, summarization, and/or structured output generation by modeling embeddings and metadata associated with content records (e.g., textual attributes, contextual relationships, engagement metrics, semantic vectors, and/or any patterns derived from metadata). For example, a subset of embeddings can be determined based on rankings (e.g., prioritization according to relevance, user activity, or engagement metrics) corresponding to at least one category (e.g., agents, evaluation, artificial intelligence (AI) security and/or safety, models, customizations). This subset can then be applied as input to at least one language model to generate summarized and/or headline content along with corresponding metadata (e.g., timestamps, source identifiers, semantic clusters, and/or engagement scores). These processes can be integrated with template-based structured outputs that can be dynamically updated based on user feedback, trend analysis, and/or changing data streams.

The systems and methods can dynamically adjust ranking functions and templates based on meta-analysis and/or retrieved content trends. For example, content records from a social media platform can be ranked (e.g., prioritized or ordered) based on engagement metrics (e.g., likes, shares, comments), semantic relationships (e.g., topic similarity, keyword matching, cluster relevance), and/or user activity data (e.g., interaction frequency, recency, historical preferences). The rankings can be updated using additional clusters derived from historical data and/or user preferences. In some implementations, structured outputs can be refined by integrating trend-based content detected through clustering and/or re-ranking mechanisms.

In some implementations, the systems and methods can provide an interactive interface, allowing users to query stored structured outputs, and receive responses generated by language models. For example, embeddings of stored outputs and user queries can be compared to retrieve the summaries, headlines, corresponding metadata, and/or new content. The retrieved content can then be used to generate responses that align with the query of user. Systems and methods disclosed herein can personalize the structured outputs, responses, and/or rankings by analyzing conversation caches and historical user data. For example, user interaction data can be clustered to generate preference-based summaries. The preference-based summaries can be used to refine the ranking functions and/or the structured outputs generated.

The systems and methods described herein can be used for a variety of applications, such as generating category-based content summaries, performing trend analysis, personalizing content delivery, facilitating interactive querying, providing customized updates, and/or any content delivery and/or categorization pipeline. For example, the systems can provide summarized content in categories. The structured outputs can be presented through various interfaces, including email, web dashboards, and/or APIs, facilitating real-time and/or scheduled updates. These implementations address the limitations of traditional content generation systems by facilitating improved categorization, summarization, and/or personalization.

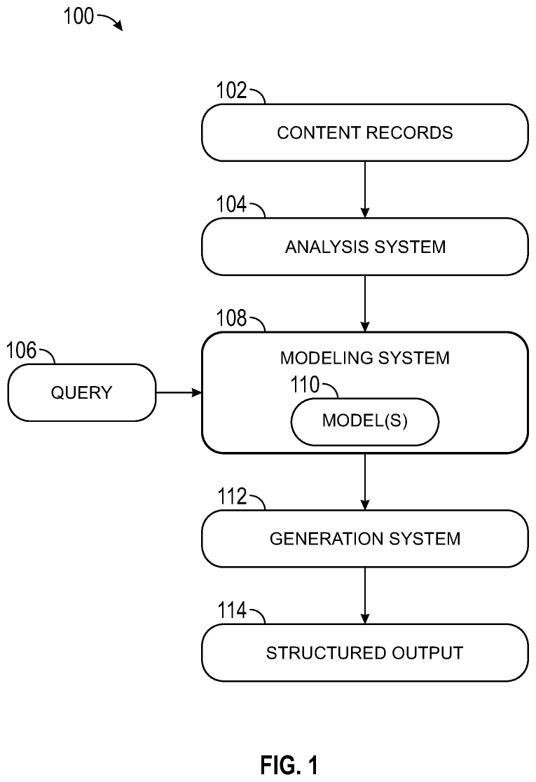

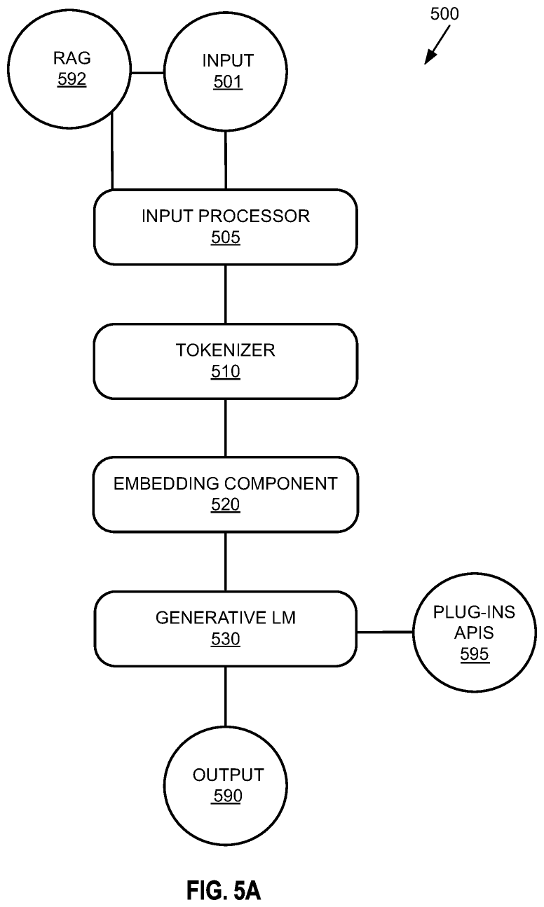

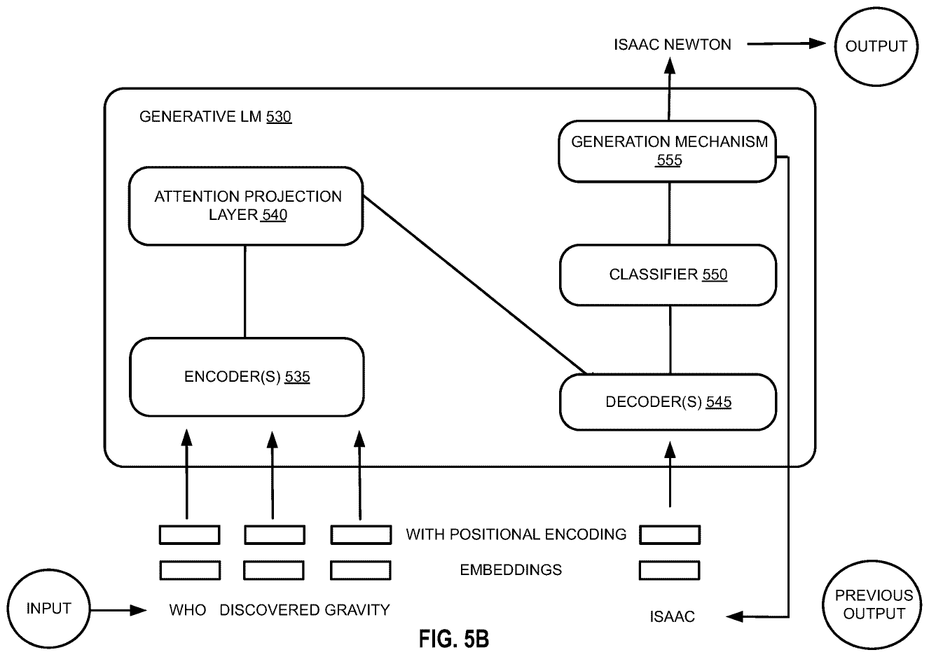

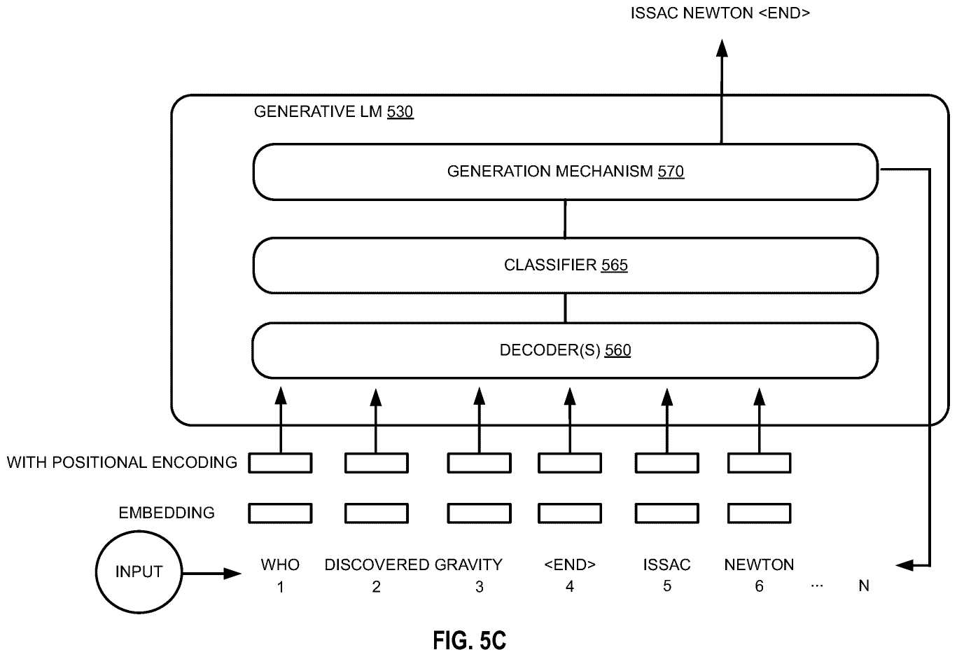

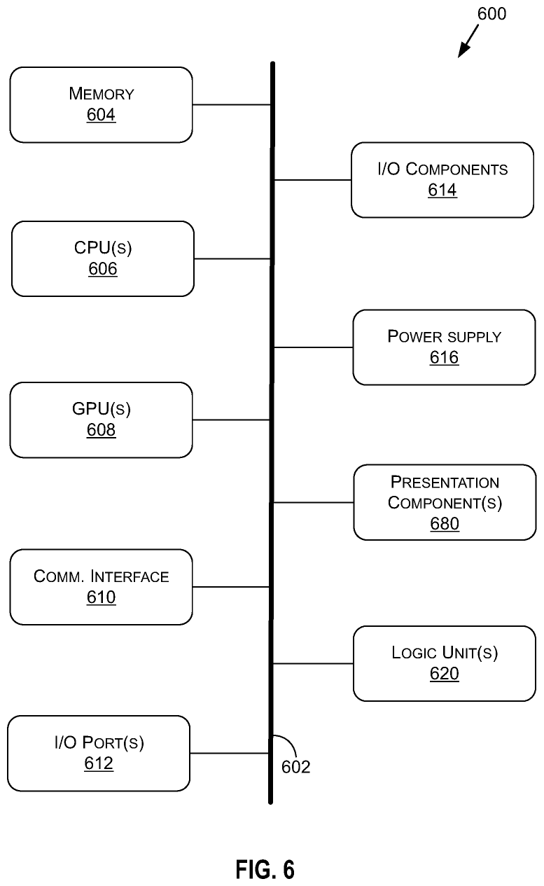

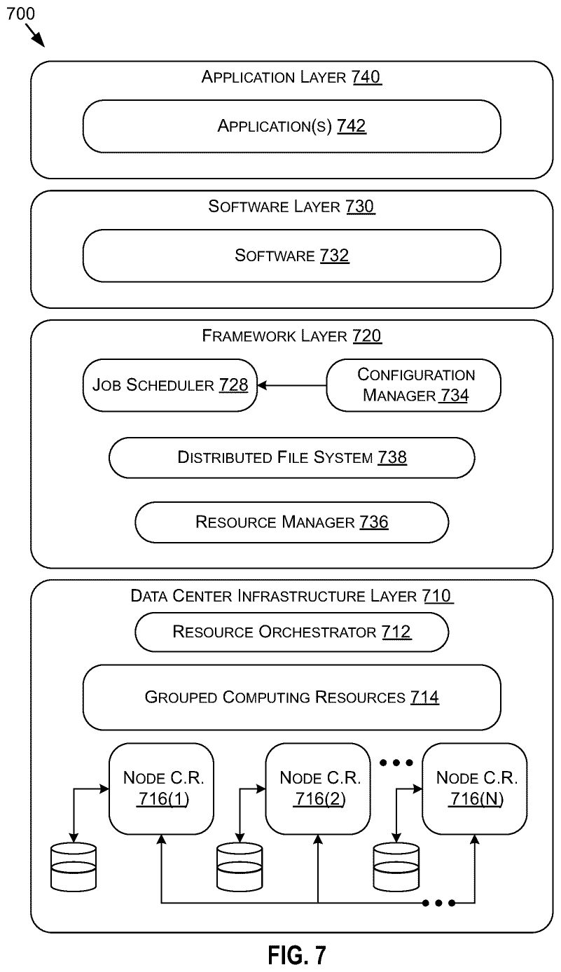

With reference to FIG. 1, FIG. 1 is an example block diagram of a system 100, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out by a processor executing instructions stored in memory. In some implementations, the systems, methods, and processes described herein can be executed using similar components, features, and/or functionality to those of example generative language model system 500 of FIG. 5A, example generative language model (LM) 530 of FIGS. 5B-5C, example computing device 600 of FIG. 6, and/or example data center 700 of FIG. 7.

The system 100 can implement at least a portion of content curation pipeline, such as but not limited to a content retrieval and ranking pipeline, a clustering and trend detection pipeline, and/or a personalized content generation pipeline. The system 100 can be used to retrieve and rank content records and/or generate structured outputs by any of various systems described herein, including but not limited to enterprise knowledge management systems, news curation systems, AI market intelligence systems, context-aware enterprise search systems, LLM internal documentation assistants systems, customer support knowledge bases, real-time monitoring systems, trend analysis systems, retrieval-augmented generation (RAG) systems, interactive querying systems, automated reporting systems, personalized recommendation systems, and/or information summarization systems.

Generally, the content curation pipeline can include operations performed by the system 100. For example, the content curation pipeline can include any one or more of an analysis stage, a modeling stage, a generating stage, a trend stage, a conversation stage, and/or a personalization stage. Each stage of the content curation pipeline includes one or more components of the system 100 that perform the functions described herein. In some implementations, one or more of the stages can be performed during the training of AI models. Additionally, one or more of the stages can be performed during the inference phase using the AI models.

The system 100 (e.g., implementing the content curation pipeline) can obtain, from at least one data source, a plurality of content records corresponding with at least one content source of the at least one data source. In some implementations, implementing the content curation pipeline can include the system 100 determining a subset of a plurality of embeddings corresponding to at least one category. That is, determining the subset of the plurality of embeddings can be based at least on a ranking of the plurality of embeddings structured according to the at least one category. Additionally, implementing the content curation pipeline can include the system 100 applying the subset of the plurality of embeddings as input to at least one language model (LM) to cause the at least one LM to generate a plurality of modified content (e.g., summarized and headline content) and corresponding metadata. In some implementations, implementing the content curation pipeline can include the system 100 generating, using the plurality of modified content (e.g., summarized and headline content) and the corresponding metadata, at least one output (e.g., structured, conversational, and/or formatted) based at least on a template. In some implementations, implementing the content curation pipeline can include the system 100 providing, via an interface, the at least one structured output. Thus, the content curation pipeline can improve content organization, retrieval precision, trend-based content structuring, and/or adaptive content personalization.

Additionally, the system 100 can further perform and/or otherwise facilitate trend analysis. In some implementations, implementing the content curation pipeline can include the system 100 obtaining the plurality of embeddings corresponding with the plurality of content records and a plurality of structure outputs. In some implementations, implementing the content curation pipeline can include the system 100 generating, using the plurality of embeddings corresponding with the plurality of contents records and a plurality of structured outputs, a plurality of clusters based on at least one similarity metric. In some implementations, implementing the content curation pipeline can include the system 100 applying the plurality of clusters as input to at least one third LM to cause the at least one third LM to generate at least one cluster representation. In some implementations, implementing the content curation pipeline can include the system 100 obtaining additional content corresponding to the at least one cluster representation based on interfacing with a plurality of data sources. In some implementations, implementing the content curation pipeline can include the system 100 updating the at least one cluster representation corresponding to at least one trend identified in the additional content. In some implementations, implementing the content curation pipeline can include the system 100 updating a ranking function based on the at least one updated cluster representation. That is, the ranking function can be used in the ranking of the plurality of embeddings. In some implementations, implementing the content curation pipeline can include the system 100 updating the at least one structured output based at least on the at least one updated cluster representation. That is, updating the at least one structured output can include at least one of (i) incorporating at least one summary of the additional content into the at least one structured output, and/or (ii) updating the corresponding metadata.

The system 100 can perform and/or otherwise facilitate conversational interactions with users. In some implementations, implementing the content curation pipeline can include the system 100 receiving, from a user device, a query corresponding to at least one of a plurality of structured outputs. In some implementations, implementing the content curation pipeline can include the system 100 generating an embedding of the query. In some implementations, implementing the content curation pipeline can include the system 100 determining, based at least on the embedding, a filtered subset of the plurality of embeddings. In some implementations, implementing the content curation pipeline can include the system 100 applying the filtered subset of the plurality of embeddings as input to the at least one LM to cause the at least one LM to generate a response to the query. In some implementations, implementing the content curation pipeline can include the system 100 providing, to the user device, the response to the query.

Additionally, the system 100 can further perform and/or otherwise facilitate personalized analyses. In some implementations, implementing the content curation pipeline can include the system 100 obtaining a conversation cache and historical conversation data based on interfacing with a plurality of data sources. In some implementations, implementing the content curation pipeline can include the system 100 generating, using the conversation cache and the historical conversation data, a plurality of clusters based at least on a preference similarity metric. In some implementations, implementing the content curation pipeline can include the system 100 applying the plurality of clusters as input to at least one fourth LM to cause the at least one fourth LM to generate at least one cluster representation. In some implementations, implementing the content curation pipeline can include the system 100 updating a ranking function based on the at least one cluster representation. That is, the ranking function can be used in the ranking of the plurality of embeddings.

Generally, the system 100 can be implemented and/or otherwise function as an agent computing system (e.g., agent core) to obtain and model structured and unstructured data. That is, the system 100 can execute predefined tasks for retrieving content records 102 from at least one data source, generating embeddings, ranking content, and applying language models to generate structured outputs. The agent core can implement rule-based and/or model-driven workflows for content categorization, trend identification, and query-based retrieval. The system 100 can maintain a processing pipeline that extracts textual and metadata attributes from content records 102, applies embedding models to transform data into vector representations, determines ranked subsets of embeddings for downstream processing, and/or generates structured outputs including applying templates. The system 100 can communicate and/or otherwise interface with external interfaces to provide structured outputs. In some implementations, the system 100 can cause presentation of the at least one output.

In some implementations, the analysis stage can be the stage in the content curation pipeline in which the system 100 can extract, filter, and/or organize content records 102 based on predefined and/or dynamically detected relevance criteria. The system 100 can include at least one analysis system 104. The analysis system 104 can obtain, from at least one data source (e.g. and without limitation, social media source (e.g., X (Twitter), Facebook, Instagram, TikTok), news source (e.g., CBS, Fox, NBC), research repositories (e.g., IEEE Xplore, Semantic Scholar), corporate knowledge bases, and/or any external or internal content aggregation systems), a plurality of content records 102 (e.g., social media posts, other news posts, academic papers, blog articles, transcripts from industry events, and/or any structured or unstructured digital content) corresponding with at least one content source (e.g., profiles and/or accounts of the social media source and/or news source) of the at least one data source. The at least one data source can include any one or more of publicly accessible, proprietary, and/or enterprise-controlled repositories supporting API-based data access and/or real-time or near real-time ingestion. The content records 102 can be a structured or unstructured digital entry containing textual, visual, and/or multimedia elements representing information disseminated through various platforms.

The content source can be an account, organization, domain, entity identifier, and/or an identified publisher of digital content. In some implementations, the at least one content source corresponds to a set of identifiers of at least one data source identified based at least on user activity data or a similarity metric to the at least one category. For example, the analysis system 104 can identify a set of users (e.g., llama users, other AI relevant accounts, thought leaders, research institutions, industry analysts, technical bloggers, corporate AI divisions) to aggregate domain-specific content for ranking and categorization

In some implementations, the analysis system 104 can obtain the content records 102 by executing scheduled API requests, web scraping, real-time or near real-time data streaming, and/or processing event-driven content ingestion pipelines. That is, the analysis system 104 can retrieve the content records 102 periodically or on demand, applying filtering and deduplication techniques prior to downstream processing. For example, during the analysis stage, the analysis system 104 can identify and remove redundant entries through similarity detection models before further categorization. In another example, the analysis system 104 can apply entity recognition and metadata extraction to enrich the content records 102 for subsequent ranking and/or retrieval operations.

In some implementations, the analysis stage can be the stage in the content curation pipeline in which the system 100 can categorize, rank, and/or prepare content records 102 for embedding-based modeling and structured output generation. The analysis system 104 can determine a subset of a plurality of embeddings corresponding to at least one category. That is, the analysis system 104 can categorize news and/or content (e.g., using a language model, such as NVIDIA NeMo, OpenAI GPT, BERT-based models, and/or any custom-trained transformer models) into user-configured groups and/or automatically detected categories (e.g., agents, evaluation, AI Security/Safety, models, customizations) and select the top-N (e.g., top-ranked entries, filtered results, curated highlights) using a re-ranking model, such as NeMo Retriever, Facebook Dense Passage Retrieval (DPR), and/or any embedding-based ranking mechanism relevant to at least one (e.g., each) category based on the latest (e.g., timestamped content freshness, real-time publishing activity, temporal decay weighting) and/or popularity (e.g., engagement scores and/or metrics (e.g., likes, thumbs up, re-posts, share), cross-platform influence, citation frequency) within the at least one (e.g., each) category. That is, determining the subset of the plurality of embeddings can be based at least on a ranking of the plurality of embeddings organized according to the at least one category. Additionally, the analysis system 104 can generate representations of social media posts, content, and/or corresponding metadata (e.g., capturing semantic relationships and/or contextual attributes).

In some implementations, the analysis system 104 can generate, using a curation model (e.g., NeMo curator, custom clustering pipelines, and/or any statistical and ML-driven content filtering approaches), a plurality of embeddings of at least one segment of the plurality of content records 102 based on at least one of (i) at least one textual element, (ii) at least one contextual attribute, or (iii) metadata of the plurality of content records 102. The segment can be a portion of the content and/or metadata of a social media post (e.g., hashtags, keywords, links, and/or any extracted named entities, inline references, topic-specific markers) and/or any structured annotation data (e.g., sentiment indicators, inferred discourse markers, and/or dynamically tagged topics). In some implementations, determining the subset of a plurality of embeddings can be based on at least on using a LM to process a plurality of relationships (e.g., semantic relationships, contextual associations, topic transition patterns, and/or any latent similarity metrics) between the plurality of embeddings and the at least one category. That is, the analysis system 104 can apply ranking functions to organize embeddings based on categorical relevance. For example, the analysis system 104 can apply similarity scoring to align embeddings with changing content trends.

The textual elements can be textual content within the content records 102 (e.g., body of a social media post, associated captions, and/or extracted phrases from linked articles or blogs). For example, a textual element can be a quoted statement, an extracted snippet from a blog post, or a headline generated from a news article. The contextual attributes can be non-textual characteristics derived from the content itself and/or use case (e.g., content category, sentiment, popularity metric such as engagement levels (likes, shares, retweets, reposts)). For example, a contextual attribute can be an inferred domain relevance score, a classification into high-priority news clusters, and/or an impact factor for assessing virality across networks. The metadata of the plurality of content records 102 can be static and/or descriptive data (e.g., timestamps, user IDs, source URLs, links to related articles). For example, metadata can be a publication date, an author attribution, a reference to external citations, and/or a detected geographic origin of content distribution.

In some implementations, the analysis system 104 can use a curation model (e.g., NeMo Curator) to facilitate preprocessing, filtering, and/or structuring of the content records 102 prior to embedding generation and ranking. The analysis system 104 can invoke the curation model via API calls and/or embedded execution to download content from structured and unstructured repositories, apply text normalization procedures (e.g., Unicode correction, tokenization, stopword removal), and/or enforce heuristic constraints such as character length thresholds and/or word frequency distributions. For example, the analysis system 104 can use the curation model to apply normalization rules that correct inconsistencies in encoding standards and/or remove incorrect or undesired artifacts in textual data. In some implementations, the analysis system 104 can employ deduplication strategies (e.g., similarity-based filtering) to identify and/or remove redundant content records 102 while preserving semantically distinct variations.

Additionally, the analysis system 104 can apply domain-specific filtering mechanisms (e.g., classifier-based quality scoring, spam detection, and/or credibility assessment) to exclude content that fails one or more data integrity criteria, such as predefined criteria. For example, the analysis system 104 can classify and filter low-quality content by using the curation model (e.g., pre-trained model) to assign domain-relevance scores, and can remove entries with scores below a threshold. The analysis system 104 can further apply probabilistic shuffling and data blending techniques (e.g., stochastic sampling, weighted mixing of multiple content sources) to improve the diversity of processed content. For example, the analysis system 104 can merge content from multiple sources to balance category representation before embedding generation. In some implementations, the analysis system 104 can execute curation operations at large-scale data volumes (e.g., terabyte or petabyte-scale processing using distributed execution frameworks).

In some implementations, the analysis system 104 can update the plurality of content records 102 based at least on at least one of (i) a similarity threshold (e.g., redundant social media posts (e.g., >98% similar), near-duplicate news articles, replicated blog entries, and/or any content with high semantic overlap) between at least two of the plurality of content records, or (ii) identifying attributes (e.g., Personally identifiable information (PII), author usernames, location metadata, and/or any sensitive data embedded in the content) in the plurality of content records. That is, the analysis system 104 can perform semantic de-duplication to remove redundant information and PII data. For example, the analysis system 104 can compare the content records 102 and/or compare embeddings of the content records 102 and remove entries exceeding the similarity threshold. In another example, the analysis system 104 can apply Named Entity Recognition (NER) to detect and redact sensitive identifiers before further processing.

In some implementations, generating embeddings of the segments can include applying tokenization, deduplication, and quality filtering operations on the textual elements, contextual attributes, and metadata of content records to generate vector representations. The curation model can be a data-processing model (e.g., NeMo Curator) to extract, clean, filter, and structure content records before embedding generation. That is, the curation model can apply heuristic and classifier-based filtering, remove redundant or low-quality content, and/or encode structured information into embeddings. In some implementations, the analysis system 104 can perform generating by executing a sequence of preprocessing steps, including text normalization, metadata extraction, and/or content deduplication, applying embedding techniques to generate numerical vector representations. That is, the analysis system 104 can use the curation model to process input content (e.g., the content records 102), and generate embeddings that preserve semantic relationships and contextual dependencies. For example, the analysis system 104 can apply a similarity search to detect and remove duplicate or near-duplicate content, perform entity recognition to extract various concepts and/or generate embeddings that encode topic relevance, sentiment, and/or engagement metrics. Additionally, the embeddings can represent structured feature vectors that capture the semantic properties of content records. For example, embeddings can encode associations between categories, keywords, sentiment polarity, and historical trends, enabling ranking, clustering, and retrieval operations within the system.

In some implementations, generating embeddings of the segments can include transforming text-based, metadata-based, and/or multimodal content into fixed-size numerical representations using a vectorization function. The curation model can be a processing model that applies feature extraction and dimensionality reduction techniques to represent the content records as embeddings (e.g., a 512-dimensional, a 768-dimensional floating-point vector, and/or any other vector). That is, the curation model can tokenize text, apply semantic encoding, and/or map content features to a continuous vector space (e.g., similar content can have closer representations).

In some implementations, the analysis system 104 can generate one or more embeddings by executing a feature encoding function on extracted content attributes, and applying a trained curation model, such as to project content records into an embedding space. That is, the analysis system 104 can generate embeddings by applying transformation functions on text, filtering metadata, and/or computing similarity-preserving representations. For example, the analysis system 104 can generate an embedding for a social media post by extracting text from the post, encoding it into a numerical vector, and associating the vector with metadata such as timestamps, user identifiers, and content source. Additionally, the embeddings can represent high-dimensional encodings of text, relationships between content elements, and/or contextual features derived from metadata. For example, an embedding of a social media post can be structured as a fixed-length vector [0.1254, −0.2945, 0.8473, . . . , −0.1934, 0.4123] stored in a vector database with associated metadata fields for indexing and retrieval. In this example, at least one (e.g., each) value in the fixed-length vector represents a learned numerical encoding of semantic attributes within the social media post, where similar numerical patterns indicate related content.

In another example, an embedding of a social media post discussing a newly released AI model can be structured as a fixed-length vector [0.2451, −0.3982, 0.7213, . . . , −0.2814, 0.5937] stored in a vector database with associated metadata fields for indexing and retrieval. In this example, the content record includes the post text “NVIDIA releases NeMo for fine-tuning LLMs with optimized retrieval!”, a timestamp, and engagement metrics (e.g., likes, shares, and comments). The embedding can be generated by the analysis system 104 by encoding the text into a high-dimensional space where semantic relationships between words—such as “NeMo,” “fine-tuning,” and “LLMs,” can be captured in numerical form.

In some implementations, the modeling stage can be the stage in the content curation pipeline in which the system 100 can generate modified content (e.g., summarized and headline content) from ranked embeddings. The system 100 can include at least one modeling system 108. The modeling system 108 can apply the subset of the plurality of embeddings as input to at least one language model (LM) (e.g., the model(s) 110) to cause the at least one LM to generate a plurality of modified content (e.g., summarized and headline content, cluster representations, template-based responses, preference summaries, query responses, topic overviews) and corresponding metadata. The plurality of summarized and headline content can be article summaries, event recaps, AI research highlights, security alerts, software updates, industry reports, technical deep dives, and/or any condensed textual representation of the original content records. That is, the modeling system 108 can use the ranked and/or filtered social media posts and/or other content, and apply the embeddings that encode the semantic and contextual meaning of the social media posts to the model(s) 110. The modified content can be generated based on processing the embeddings using the model(s) 110. That is, the modified content can be a condensed version of the original content that highlights various aspects or topics. The corresponding metadata can be a source link (e.g., URL, author identifier, timestamp, reference citation, and/or any content identifier) of the original content record 102.

Generally, the modeling system 108 can generate modified content (e.g., summarized and headline content) based on embeddings representing social media posts, news articles, and/or other digital content. In some implementations, the modeling system 108 can apply and/or otherwise generate modified content by extracting textual components from the embeddings, and applying language model transformations. That is, the modeling system 108 can generate a condensed representation of the content records by restructuring, reformatting, and/or extracting key textual components encoded in the embeddings. For example, the modeling system 108 can generate summaries by identifying primary statements, extracting relevant entities, and constructing headline-style content while maintaining semantic coherence.

The modeling system 108 can include any one or more artificial intelligence models (e.g., machine learning models, supervised models, neural network models, deep neural network models), rules, heuristics, algorithms, functions, or various combinations thereof to perform various operations. That is, model(s) 110 can be a neural network and/or machine-learning (ML) model trained to generate various outputs (e.g., summarized and headline content, templates, cluster representations, responses, subset of embeddings). In some implementations, the modeling system 108 can output modified content, templates, cluster representations, embeddings of segments of the content records 102, a subset of embeddings based on processing relationships between the embeddings, responses to queries (e.g., the query 106), and/or any ranking scores for content prioritization, topic affinity measures, structured query responses, and/or updated content associations. In some implementations, the output can be a structured output 114 based on one or more templates used in training the model(s) 110 and/or performing inference operations.

Generally, referring to the various models described herein, such as the various language models to perform clustering, generating, summarizing, and/or any other outputs. In some implementations, the modeling system 108 can maintain, execute, train, update, and/or otherwise process, refile, or apply one or more artificial intelligence (AI) models during the modeling stage. The AI model(s) can be or include a transformer-based model (e.g., a generative pre-trained transformer (GPT) model, a bidirectional encoder representations from transformers (BERT)). The modeling system 108 can execute the AI model to generate outputs. The modeling system 108 can receive data to provide as input to the AI model(s).

In some implementations, the modeling system 108 can execute one or more AI models (e.g., model(s) 110) by using a modeling framework to improve the performance of the AI model during the modeling stage. The framework can include implementing techniques such as gradient descent, backpropagation, and distributed training. The AI model(s) can incorporate mechanisms such as regularization and weight pruning to maintain efficiency and prevent overfitting. For example, during execution, the modeling system 108 can partition input data into mini-batches, apply loss functions, and/or update model parameters iteratively. The AI models can support inference operations that include processing feature vectors, transforming raw input data, and generating probabilistic predictions and/or metrics. The modeling system 108 can integrate hardware accelerators such as GPUs or TPUs based on computational demands.

For example, the output can be modified content (e.g., summarized and headline content) based on applying a subset of a plurality of embeddings. In some implementations, the embeddings can be provided to model(s) 110 to perform natural language processing operations, including sequence-to-sequence transformation and contextual encoding. In some implementations, the AI model(s) can include any type of AI model capable of text summarization, entity recognition, and relationship extraction (e.g., extractive summarization models, abstractive summarization models) to generate outputs while maintaining semantic relevance. For example, the AI model(s) can be trained and/or updated to apply attention mechanisms to determine key phrases, filter redundant information, and/or structure the output in a ranked format.

In another example, the output can be a template based on a schema and/or a structure parameter corresponding with organizing the modified content and/or corresponding metadata. In some implementations, the schema and/or a structure parameter can be provided to model(s) 110 to perform content organization and formatting according to predefined structural rules. In some implementations, the AI model(s) can include any type of AI model trained to perform document structuring and content alignment (e.g., document layout transformers, hierarchical text processors) to format summarized content for presentation and indexing. For example, the AI model(s) can be trained and/or updated to apply predefined schema constraints, enforce section-based formatting, and generate templates.

In yet another example, the output can be a cluster representation based on a plurality of clusters according to similarity metrics. In some implementations, the clusters can be provided to model(s) 110 to perform semantic grouping and density-based clustering for topic aggregation. In some implementations, the AI model(s) can include any type of AI model capable of hierarchical clustering, density-based clustering, and/or k-means clustering group related embeddings based on statistical and/or geometric relationships. For example, the AI model(s) can be trained and/or updated to analyze cosine similarity between embedding vectors, apply distance-based thresholds for cluster formation, and/or label clusters based on detected topic distribution.

In yet another example, the output can be embeddings of at least one segment of the content records 102 (also referred to herein as “content assets”) based on textual elements, contextual attributes, and/or metadata of the content records 102. In some implementations, the segment of the content records 102 can be provided to model(s) 110 to perform vectorized representation learning and/or feature extraction. In some implementations, the AI model(s) can include any type of AI model capable of dimensionality reduction and contextual representation learning (e.g., word2vec, sentence-BERT, transformer-based embeddings) to generate dense vector representations that encode semantic and syntactic relationships between words and/or phrases. For example, the AI model(s) can be trained and/or updated to apply tokenization, encode multi-dimensional feature vectors, and/or normalize embeddings.

In yet another example, the output can be a response to a query 106 based on a filtered subset of embeddings. In some implementations, the filtered subset of embeddings can be provided to model(s) 110 to perform retrieval-augmented generation and query-driven content synthesis. In some implementations, the AI model(s) can include any type of AI model capable of neural retrieval and sequence-to-sequence generation (e.g., retrieval-augmented transformers) to generate responses that incorporate contextualized information from ranked embeddings. For example, the AI model(s) can be trained and/or updated to retrieve the top-k most relevant embeddings, apply passage ranking techniques, and/or synthesize responses using transformer-based text generation models.

In yet another example, the output can be a cluster representation based on a plurality of clusters according to preference similarity metrics. In some implementations, the clusters can be provided to model(s) 110 to perform user preference modeling and adaptive content filtering. In some implementations, the AI model(s) can include any type of AI model capable of filtering, content-based recommendation, and graph-based clustering (e.g., reinforcement learning-based ranking, personalized content embeddings) to update content prioritization based on historical user interactions. For example, the AI model(s) can be trained and/or updated to track preference evolution over time, adjust ranking scores, and/or update content delivery.

In yet another example, the output can be a subset of embeddings based on relationships between the embeddings (e.g., in a category). In some implementations, the relationships between the embeddings can be provided to model(s) 110 to perform semantic similarity computation and knowledge graph embedding. In some implementations, the AI model(s) can include any type of AI model capable of vector similarity search and topic modeling (e.g., cosine similarity networks, graph convolutional networks (GCNs)) to determine entity relationships and/or topic hierarchies. For example, the AI model(s) can be trained and/or updated to identify latent topic transitions, refine category boundaries using embedding distances, and/or establish hierarchical dependencies between content clusters.

In some implementations, the modeling system 108 can evaluate trained models using various metrics (e.g., precision, recall, performance, and/or F1 score) to determine readiness for deployment and/or inference operations. The evaluation can include analyzing model performance on validation datasets, testing datasets, or real-world data inputs to assess consistency and robustness. For example, the modeling system 108 can compare model predictions against ground truth data to determine accuracy metrics, error rates, and/or confidence intervals. In another example, the modeling system 108 can track performance variations over multiple evaluation cycles to identify potential degradation and/or drift in model accuracy. The evaluation can include the modeling system 108 applying techniques such as cross-validation, Monte Carlo simulations, and/or adversarial testing to measure resilience against noise or distributional shifts. In some implementations, the modeling system 108 can generate performance metrics and/or data structures including metric values, confusion matrices, and/or calibration plots to identify model effectiveness. The performance metrics and/or data structures can be used to facilitate retraining procedures, model adjustments, and/or fine-tuning processes if evaluation criteria are not met. The modeling system 108 can integrate threshold-based criteria, such as enforcing an F1 score above a predefined value, before permitting the model(s) 110 to be deployed for inference. In some implementations, model evaluation can include automated testing pipelines that perform predefined test cases, analyze false positive and false negative rates, and/or apply statistical significance tests to validate improvements.

In some implementations, the modeling system 108 can include at least one AI model (e.g., model(s) 110). The model(s) 110 can include an input layer, an output layer, and/or one or more intermediate layers, such as hidden layers, which can each have respective nodes. That is, the model(s) 110 can process embeddings of content records and/or assets, and generate outputs based on learned patterns. For example, the input layer can receive embeddings of content records, contextual metadata, and/or user queries, and transform them into a numerical representation suitable for processing by the model(s) 110. For example, the output layer can generate summarized and headline content, structured templates, ranked content categories, and/or responses to user queries based on the processed embeddings. For example, the intermediate layers can apply transformations such as attention mechanisms, recurrent processing, or convolutional operations to extract semantic relationships, identify topic relevance, and/or adjust content ranking before generating the final output (e.g., structured).

In some implementations, the modeling system 108 can configure (e.g., train, update, fine tune, apply transfer learning to) the model(s) 110 by modifying or updating one or more parameters, such as weights and/or biases, of various nodes of the model(s) 110 responsive to evaluating estimated outputs of the model(s) 110 (e.g., generated in response to receiving training examples in a training dataset, such as a training dataset). The modeling system 108 can be or include various neural network models, including models that can operate on or generate data including but not limited to summarized and headline content, templates, cluster representations, responses, subset of embeddings, and/or various combinations thereof.

In some implementations, the modeling system 108 can be configured (e.g., trained, updated, fine-tuned, has transfer learning performed, etc.) based at least on the training data of the at least one training dataset. For example, one or more example summarized and/or headline content, templates, cluster representations, responses, subset of embeddings of the training data can be applied (e.g., by the system 100 and/or in a pre-training and/or tuning process performed by the system 100 or another system) as input to the modeling system 108 to cause the model(s) 110 to generate an estimated output. The estimated output can be evaluated and/or compared with ground truth data of the training data that correspond with the one or more examples, and the model(s) 110 of the modeling system 108 can be updated based at least on the comparison and/or various performance metrics.

In some implementations, the modeling system 108 can implement and/or otherwise facilitate a pre-training in which model(s) 110 is trained on large-scale, unstructured datasets to learn foundational representations. The pre-training can include self-supervised learning techniques such as masked token prediction, next-token prediction, contrastive learning, and/or denoising objectives to develop generalized feature representations. For example, the model(s) 110 can be exposed to large corpora to extract statistical patterns, semantic relationships, and/or latent structures. In another example, the model(s) 110 can apply unsupervised clustering techniques to identify recurrent patterns and correlations in the training data. The pre-training phase can include updating model parameters based on loss functions computed from predicting missing or corrupted data points. The modeling system 108 can apply distributed training techniques, including data parallelism, model parallelism, and/or pipeline parallelism, to optimize the computational efficiency of pre-training. The output of the pre-training phase can be used to initialize the model(s) 110 for subsequent fine-tuning on domain-specific tasks.

In some implementations, the modeling system 108 can implement and/or otherwise facilitate fine-tuning in which model(s) 110 is updated to specific tasks (e.g., generating summarized and/or headline content, generating templates, generating cluster representations, generating responses, generating subset of embeddings) using domain-specific training datasets. The fine-tuning process can include supervised learning, reinforcement learning, and/or contrastive learning to refine the pre-trained representations. For example, the modeling system 108 can adjust model parameters by minimizing task-specific loss functions, update weights based on labeled examples, and apply backpropagation to improve task performance. The modeling system 108 can update the model(s) 110 by adjusting weights, biases, and/or layer-specific parameters based on task-specific loss functions. For example, fine-tuning can include backpropagation-based updates using labeled datasets in which the model(s) 110 can be trained to minimize classification errors, prediction uncertainties, and/or inference inconsistencies. In some implementations, fine-tuning can be performed using techniques such as low-rank adaptation (LoRA), adapter layers, and/or selective parameter freezing to reduce computational costs while preserving generalization capabilities. The modeling system 108 can iteratively evaluate the model(s) 110 on validation datasets to track performance changes, mitigate overfitting, and/or determine convergence criteria. Fine-tuning outputs can be evaluated against reference benchmarks to assess task alignment, efficiency improvements, and/or robustness against adversarial inputs.

In some implementations, the modeling system 108 can implement and/or otherwise facilitate retrieval-augmented generation (RAG) models to improve output quality of the model(s) 110 by incorporating external knowledge sources. The RAG architecture can include a retrieval system and a generation system, where the retrieval system of modeling system 108 can fetch relevant documents, embeddings, or structured data from knowledge bases, and the generation system of modeling system 108 can synthesize responses using retrieved content. The modeling system 108 can use vector search techniques such as FAISS, approximate nearest neighbor (ANN) search, and/or BM25 ranking to identify relevant retrieval candidates. For example, the model(s) 110 can retrieve contextually relevant passages from an indexed database and use the retrieved content as additional input for generating responses. In some implementations, the modeling system 108 can dynamically update retrieval parameters based on query complexity, information density, and/or response ambiguity. The retrieval process can be reinforced using feedback mechanisms, where low-confidence generations trigger additional retrieval iterations. The modeling system 108 can integrate hybrid approaches that combine parametric memory from the model(s) 110 with non-parametric retrieval sources to balance computational efficiency and factual accuracy.

In some implementations, the modeling system 108 can implement and/or otherwise facilitate a sparse expert-based model architecture. The model(s) 110 can use a Mixture of Experts (MoE) framework, where a subset of expert networks can be dynamically activated per inference step based on input characteristics. The MoE structure can include multiple specialized sub-networks, at least one (e.g., each) trained on different aspects of data processing, and a gating mechanism that selects the relevant experts for a given query. In some implementations, the modeling system 108 can include optimizations such as multi-head latent attention, which reduces memory overhead by compressing and reconstructing key-value pairs dynamically, minimizing cache storage requirements during inference. The model(s) 110 can integrate both local and global attention mechanisms, where local attention can process immediate token relationships and global attention can capture long-range dependencies. Additionally, the model(s) 110 can implement soft token merging to reduce redundant input tokens and dynamic token inflation to restore details during later processing stages. The modeling system 108 can further improve inference performance by employing hardware acceleration techniques, including tensor parallelism and/or memory-efficient caching strategies. The system 100 can execute the sparse expert-based model architecture (e.g., the model(s) 110) for natural language processing, reasoning-based tasks, structured data transformation, and/or multimodal data generation.

In some implementations, the modeling system 108 can receive at least one query 106. The query 106 can correspond to a user query specifying a particular timeline (e.g., past week, past month, past quarter) for AI trends, other trends, and/or any structured content retrieval task. That is, the modeling system 108 can process the query 106 by embedding the query, retrieving a filtered subset of embeddings (e.g., top K relevant social media posts) from a vector database based on similarity metrics (e.g., cosine similarity, approximate nearest neighbor (ANN) search), and applying the retrieved embeddings as input to at least one LM to generate a response. For example, a query 106 can include a prompt such as “Generate AI trends for the past three months,” where the modeling system 108 retrieves relevant embeddings of content assets (also referred to herein as “content records”), clusters the retrieved content, applies ranking adjustments based on temporal relevance, and/or generates a structured trend summary. In another example, the query 106 can correspond to an inquiry such as “Summarize recent advances in large language models,” where the modeling system 108 can extract metadata-linked embeddings, identify recurring themes across content clusters, and/or generate a response including summarized insights.

In some implementations, the generating stage can be the stage in the content curation pipeline in which the system 100 can generate outputs (e.g., a structured output 114) based on ranked embeddings and summarized content. The system 100 can include at least one generation system 112. The generation system 112 (and/or the model(s) 110 used by the modeling system 108) can generate, using the plurality of modified content, and the corresponding metadata, at least one structured output 114 based at least on a template. For example, the model(s) 110 can output modified content, and the generation system 112 can format the content into a predefined schema, incorporating sections such as key insights, trending topics, citations, and/or category-specific highlights. In this example, the structured output 114 can include organized content sections based on extracted metadata, where at least one (e.g., each) section corresponds to a specific attribute of the summarized content (e.g., source attribution, timestamps, and contextual tags). In another example, the model(s) 110 can generate a structured output 114 satisfying one or more templates. In this example, the structured output 114 can be dynamically selected based on content type, category, and/or audience preference, where different formats can be applied for various use cases such as technical reports, industry newsletters, and/or research digests.

In some implementations, the generation system 112 can fill and/or otherwise populate a template having predefined elements such as categories and key trends, other sections, graphics, tables, statistical summaries, ranked lists, and/or any structured content elements. The template can be a final newsletter template, schema template, structured document template, interactive report template, and/or any format used for organizing structured content. For example, during the generating stage the generation system 112 can apply predefined formatting rules to arrange content in designated sections of the structured output 114.

In some implementations, the generation system 112 can generate and/or otherwise format the structured output 114 by applying content placement rules based on metadata attributes, ranking scores, and/or categorization labels. The structured output 114 can be a digital document, an interactive dashboard, a report, and/or a structured dataset for downstream applications. That is, the output can structure, organize, format, and present modified content with associated metadata for consumption by users or systems. For example, the generation system 112 can construct a structured output 114 by inserting ranked summaries into category-specific sections and embedding source metadata for contextual reference.

In some implementations, the generation system 112 can provide, via an interface, the at least one structured output 114. That is, the interface can be any communication channel such as email, GUI, and/or API. For example, the generation system 112 can transmit the structured output 114 as an automated email containing summarized content, metadata references, and categorized insights. In another example, the generation system 112 can provide the structured output 114 via an API endpoint, allowing external systems to query and retrieve structured content dynamically. In some implementations, the generation system 112 can cause presentation of the at least one structured output 114. That is, the structured output 114 can be rendered on a client device in a graphical layout corresponding with the applied template. For example, the structured output 114 can be displayed within a web-based dashboard interface organized by content type, timestamp, and source metadata. Causing can be facilitated and/or otherwise initiated by rendering logic executed on the client device or invoked by a backend system (e.g., server-side content delivery system, rendering microservice). That is, causing can include executing code to retrieve the structured output 114, parsing the content and metadata, and/or rendering the structured output 114 into a visual interface using a rendering engine (e.g., WebGL), markup processor (e.g., HTML parser), or UI framework (e.g., React). Additionally, providing the structured output 114 can be time-based such that content delivery is scheduled based on predefined intervals, user preferences, and/or detected trends in incoming data. For example, the generation system 112 can generate and distribute structured outputs daily, weekly, and/or upon detecting changes (e.g., significant) in ranked content categories.

Generally, the generation system 112 can apply content organization rules, formatting logic, and structured presentation techniques (e.g., template parameters and/or restrictions) to transform summarized content into structured outputs. In some implementations, the generation system 112 can update templates dynamically by updating content placement, section ordering, and/or metadata inclusion based on ranking scores and detected patterns. That is, the generation system 112 can update template structures based on content volume, priority rankings, and/or user-specified configurations. For example, the generation system 112 can rearrange sections in the structured output 114 to prioritize the highest-ranked content categories and maintain predefined formatting constraints.

In some implementations, the generation system 112 and/or the model(s) 110 of the modeling system 108 can be used to generate the template based at least on at least one schema or at least one structure parameter corresponding with organizing the plurality of modified content (e.g., summarized and headline content) and the corresponding metadata. The schema can be a format (e.g., of a newsletter) that can be a predefined organizational framework or model defining how content and metadata are structured in the output. The structure parameter can be layout parameters, placement parameters, metadata associations, look and feel parameters, and/or any content or representation parameters. That is, generating the template can include defining content sections, establishing metadata mappings, and/or specifying relationships between structured elements. For example, the generation system 112 can generate a template by assigning predefined categories to specific content sections, linking summaries to corresponding metadata fields, and/or determining display order based on ranking scores.

In some implementations, the modeling system 108 can apply the model(s) 110 to generate a structured output 114 based on a template, where summarization and formatting occur within a single stage of the content curation pipeline. That is, the modeling system 108 can process the subset of the plurality of embeddings as input to the model(s) 110, where the model(s) 110 can generate structured content formatted according to a predefined schema, incorporating modified content, corresponding metadata, and category-based organization. In some implementations, the structured output 114 can be generated by embedding summarization and templating processes where the model(s) 110 apply both content condensation and structural formatting in an operation.

In some implementations, the trend stage can be the stage in the content curation pipeline in which the system 100 can obtain the plurality of embeddings corresponding with the plurality of content records and a plurality of structure outputs. The modeling system 108 can retrieve the plurality of embeddings from a vector store (e.g., Qdrant, local storage), and apply at least one similarity metric (e.g., cosine similarity, Euclidean distance) to generate, using the plurality of embeddings (e.g., corresponding with the plurality of contents records and a plurality of structured outputs), a plurality of clusters. That is, the modeling system 108 can process embeddings stored in the vector store to group content records into clusters based on relationships such as semantic similarity, contextual relevance, and/or categorical alignment. For example, during the trend stage, the modeling system 108 can apply clustering techniques (e.g., k-means, hierarchical clustering, or density-based clustering) to embeddings corresponding to social media posts, articles, and metadata. In some implementations, the modeling system 108 can apply the plurality of clusters as input to at least one third LM (e.g., the model(s) 110) to cause the at least one third LM to generate at least one cluster representation (e.g., a condensed summary of grouped content records based on semantic similarity, thematic relevance, and/or contextual overlap). That is, the modeling system 108 can process the clusters using the third LM to extract representative features, generate textual descriptions of the theme of the cluster, and/or associate at least one (e.g., each) cluster with a broader trend category. For example, the modeling system 108 can generate textual representations of AI research trends by processing clusters of embeddings corresponding to research publications and social media discussions.

In some implementations, the modeling system 108 can obtain additional content corresponding to the at least one cluster representation based on interfacing with a plurality of data sources. That is, after generating the cluster representation, the modeling system 108 can retrieve supplementary content from external or internal sources (e.g., web sources, structured databases, and/or real-time feeds) that correspond to the cluster representation. For example, the modeling system 108 can obtain recent publications, blog posts, and/or related discussions from indexed repositories to expand the cluster representation (e.g., additional information on the identified trend). In this example, an identified trend can be emerging techniques in AI model distillation, and the additional content can be research papers discussing improvement strategies.

The modeling system 108 can update the at least one cluster representation corresponding to at least one trend identified in the additional content. That is, the modeling system 108 can refine or expand the cluster representation based on newly retrieved content by modifying the semantic attributes of the cluster, updating weighting parameters, and/or incorporating additional metadata. For example, the modeling system 108 can update a representation of an AI research trend by integrating newly published articles related to that trend. The modeling system 108 can update a ranking function (e.g., a function assigning priority scores to embeddings based on relevance, recency, and/or engagement metrics) based on the at least one updated cluster representation, the ranking function used in the ranking of the plurality of embeddings. That is, the ranking function can update content rankings within the embeddings to prioritize and/or deprioritize certain content based on its association with the updated trend representation. For example, the modeling system 108 can update the ranking of AI-related embeddings in response to shifts in research focus detected through newly obtained content.

In some implementations, the modeling system 108 can update the at least one output (e.g., structured) based at least on the at least one updated cluster representation. Updating the at least one structured output can include at least one of (i) incorporating at least one summary of the additional content into the at least one structured output 114, and/or (ii) updating the corresponding metadata. That is, the structured output 114 can be modified to reflect the changes in cluster representations by inserting summaries derived from new content or revising metadata fields such as source references or timestamps. For example, the modeling system 108 can revise a structured output 114 of an AI newsletter by adding a new summary section identifying and/or otherwise highlighting an emerging research topic identified in the updated cluster representation.

In some implementations, the conversation stage can be the stage in the content curation pipeline in which the system 100 can receive, from a user device, a query 106 corresponding to at least one of a plurality of structured outputs. The modeling system 108 can process the received query 106 by extracting relevant tokens, and applying text normalization techniques to standardize the input format. That is, the modeling system 108 can preprocess the query 106 to remove extraneous elements, identify intent, and/or associate the query 106 with structured outputs (e.g., historical structured outputs) stored in a vector database. For example, during the conversation stage, the modeling system 108 can parse a user-submitted query such as “Summarize the latest AI security updates” and associate it with structured outputs related to AI security trends.

In some implementations, the modeling system 108 can generate an embedding of the query 106. That is, the modeling system 108 can convert a textual query and/or other multimodal query (e.g., audio, video) into a numerical representation using an embedding model (e.g., the model(s) 110), capturing the semantic meaning of the request of the user. For example, the modeling system 108 can apply a transformer-based embedding model (e.g., BERT, Sentence-BERT, a NeMo Retriever model, and/or any of the model(s) 110) to map the query into a high-dimensional vector space. The modeling system 108 can determine, based at least on the embedding, a filtered subset of the plurality of embeddings. That is, the modeling system 108 can retrieve embeddings from a vector database that are most relevant (e.g., closest in vector space based on content similarity and/or contextual fit) to the query embedding based on similarity metrics such as cosine similarity and/or approximate nearest neighbor (ANN) search. For example, the modeling system 108 can retrieve outputs related to AI security updates by selecting embeddings with the highest similarity scores relative to the query embedding.

In some implementations, the modeling system 108 can apply the filtered subset of the plurality of embeddings as input to at least one LM (e.g., the model(s) 110) to cause the at least one LM to generate a response to the query. That is, the modeling system 108 can process the retrieved embeddings using a language model to generate a textual response summarizing the most relevant outputs (e.g., structured). For example, the modeling system 108 can use a fine-tuned generative model (e.g., a retrieval-augmented generation (RAG) model) to synthesize a response such as “The latest AI security updates include advancements in adversarial training techniques and model robustness improvements.” The modeling system 108 can provide, to a user device, the response to the query 106. That is, the generated response can be formatted and transmitted via an interface (e.g., API response, web dashboard, email). For example, the modeling system 108 can send the generated response as a structured text output via an interactive chatbot interface, allowing users to request additional refinements and/or follow-up queries.

In some implementations, the personalization stage can be the stage in the content curation pipeline in which the system 100 can obtain a conversation cache and historical conversation data based on interfacing with a plurality of data sources. The modeling system 108 can retrieve prior user interactions, stored structured outputs, and conversation history from local and/or external data repositories. That is, the modeling system 108 can extract user interaction data from cache storage (e.g., Redis cache storing active conversations) and historical logs (e.g., VDB historical conversation store) to analyze recurring topics, preferences, and/or engagement patterns. For example, during the personalization stage, the modeling system 108 can access historical conversations related to AI model evaluations, cybersecurity trends, and/or research discussions to refine content recommendations. Additionally, the system can integrate real-time user feedback by analyzing updates from active conversation sessions, updating future structured outputs based on detected shifts in user interests.

In some implementations, the modeling system 108 can generate, using the conversation cache and the historical conversation data, a plurality of clusters based at least on a preference similarity metric (e.g., user interaction frequency, semantic similarity of prior queries, engagement-based topic correlation, and/or inferred content affinity based on past interactions). That is, the modeling system 108 can apply clustering techniques (e.g., k-means, hierarchical clustering, density-based clustering) to group conversation data based on similarity metrics such as topic affinity, engagement frequency, and/or contextual relevance. For example, the modeling system 108 can cluster user interactions related to AI governance policies separately from clusters focused on model interpretability. The clustering process can use embeddings from the stored conversations to create associations between user engagement patterns and previously stored topics. Additionally, clustering can incorporate engagement metadata, such as response frequency, query depth, and/or explicit feedback (e.g., upvotes/downvotes on generated responses), to refine similarity measures dynamically.

In some implementations, the modeling system 108 can apply the plurality of clusters as input to at least one fourth LM (e.g., the model(s) 110) to cause the at least one fourth LM to generate at least one cluster representation. That is, the modeling system 108 can process the clustered conversation data using a language model (e.g., a long-context LM) to generate structured representations of user preferences. For example, the modeling system 108 can apply a transformer-based model (e.g., GPT, BERT, a NeMo-based model, and/or any of the model(s) 110) to generate a descriptive summary of past interests of the user, such as “User frequently engages with AI security discussions, focusing on adversarial robustness and federated learning.” The cluster representation can be further refined through trend aggregation and deduplication mechanisms (e.g., reducing redundant data across stored and active conversation inputs). In some implementations, the cluster representation can incorporate statistical measures (e.g., term frequency-inverse document frequency (TF-IDF) scores and/or latent semantic indexing (LSI)), to capture the most relevant and distinguishing aspects of user interactions.

In some implementations, the modeling system 108 can update a ranking function based on the at least one cluster representation, the ranking function used in the ranking of the plurality of embeddings. That is, the modeling system 108 can refine content retrieval and ranking processes by updating weighting factors in the ranking function based on personalized clusters. For example, the modeling system 108 can increase the ranking priority of AI security-related structured outputs for a user who has demonstrated consistent engagement with cybersecurity topics, ensuring that future recommendations are customized to historical interactions and detected preferences. The updated ranking function can influence the generation of structured outputs that reflect personalized content recommendations. The ranking function can be further improved by using reinforcement learning models that adjust ranking weights dynamically based on real-time or near real-time user feedback and implicit interaction signals, such as click-through rates, response dwell times, and/or multi-turn conversation patterns.

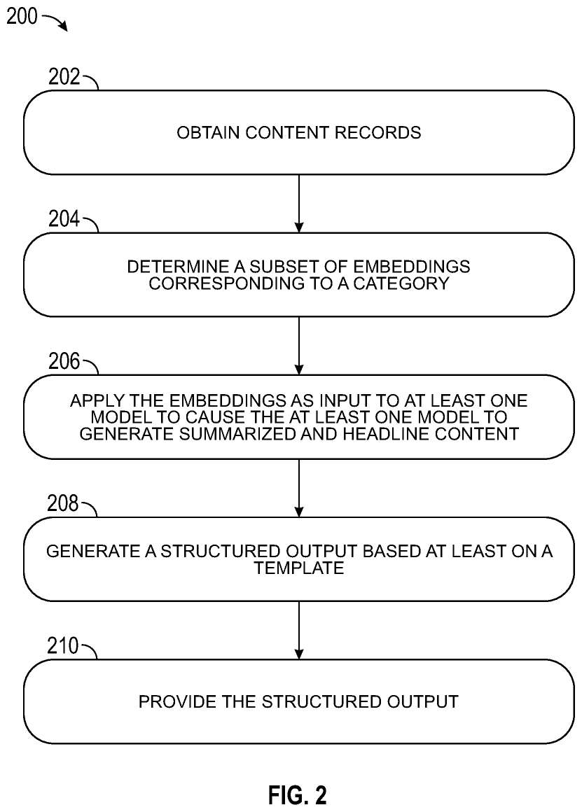

With reference to FIG. 2, an example flow diagram illustrating a method 200 for content modeling and structured output generation in a content curation pipeline, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out using one or more processor executing instructions stored in one or more memories. For example, in some implementations, the system and methods described herein can be implemented using one or more generative language models (e.g., as described in FIGS. 5A-5C), one or more computing devices or components thereof (e.g., as described in FIG. 6), and/or one or more data centers or components thereof (e.g., as described in FIG. 7).

Now referring to FIG. 2, each block of method 200, described herein, includes a computing process that can be performed using any combination of hardware, firmware, and/or software. For example, various functions can be carried out using one or more processors executing instructions stored in one or more memories. The method can also be embodied as computer-usable instructions stored on computer storage media. The method can be provided by a standalone application, a service or hosted service (standalone or in combination with another hosted service), as a microservice via an application programming interface (API) or a plug-in to another product, to name a few. In addition, method 200 is described, by way of example, with respect to the system of FIG. 1. However, this method can additionally or alternatively be executed by any one system, or any combination of systems, including, but not limited to, those described herein.

FIG. 2 is a flow diagram showing a method 200 for obtaining, determining, applying, generating, providing, updating, and/or receiving operations (among other operations), in accordance with some implementations of the present disclosure. Various operations of method 200 can relate to improving the processing, structuring, and ranking of content records and/or assets to generate summarized and structured outputs. Existing systems often rely on and/or use static content aggregation methods and non-adaptive ranking mechanisms, which can lead to inefficient content selection, redundancy, and/or a lack of personalization. The existing technological problems can arise when these systems fail to dynamically rank and categorize content based on relevance, context, and temporal factors, resulting in outdated and/or irrelevant outputs. Method 200 of FIG. 2 can solve these technological problems by implementing a ranking function that refines embeddings using language models, clustering techniques for trend identification, and/or retrieval-augmented generation (RAG) models for context-aware summarization, thereby improving content relevance, adaptability, and/or structured presentation.

The method 200, at block 202, includes obtaining, from at least one data source, a plurality of content records and/or assets (e.g., social media posts, other news posts, articles, research) corresponding with at least one content source (e.g., profiles and/or accounts of the social media source and/or news source) of the at least one data source. For example, the data sources can be social media sources (e.g., X (Twitter), Facebook, Instagram, TikTok), news sources (e.g., CBS, Fox, NBC), and/or other content sources.

The method 200, at block 204, includes determining a subset of a plurality of embeddings (e.g., generated representations of social media posts and/or corresponding metadata, capturing semantic relationships and/or contextual attributes) corresponding to at least one category. That is, the processing circuits (also referred to herein as “processing circuitry”) can determine the subset of the plurality of embeddings can be based at least on a ranking of the plurality of embeddings organized according to the at least one category. The subset can be a categorization of the content records and/or corresponding metadata into user configured groups and/or automatically detected categories (e.g., agents, evaluation, AI Security/Safety, models, customizations). Additionally, the subset can include the top-N most relevant news items for at least one (e.g., each) category, selected based on various parameters such as a temporal parameter (e.g., recency) and an interaction parameter (e.g., engagement level), where relevance is determined using a re-ranking model (e.g., a NeMo Retriever).

The method 200, at block 206, includes applying the subset of the plurality of embeddings as input to at least one language model (LM) (e.g., inference call and/or request) to cause the at least one LM to generate (e.g., process the embeddings) a plurality of modified and/or updated content and corresponding metadata (e.g., source links, URLs, other information). That is, the processing circuits can apply the embeddings (e.g., including the ranked and/or filtered social media posts) encoding the semantic and contextual meaning of the social media posts. For example, the summarized and headline content can a condensed versions of the original content and highlights of key aspects or topics.

In some implementations, at block 206, the processing circuits can generate, using at least one LM, at least one output including a plurality of modified and/or updated content and corresponding metadata. That is, the at least one structured output can be generated based at least one the subset of the plurality of embeddings and/or at least one template. In some implementations, at block 206, the processing circuits can apply the subset of the plurality of embeddings as input to at least one language model (LM) to cause the at least one LM to generate, using a template, at least one structured output including a plurality of modified and/or updated content and corresponding metadata. That is, while block 208 is described as generating the structured output using at least one template, it should be understood that the processing circuits, using the at least one LM, can dynamically adjust content placement, modify metadata associations, and/or incorporate additional annotations based on contextual relevance. For example, the at least one LM can be trained and/or otherwise implemented to generate structured outputs that satisfy one or more templates (e.g., integrate adaptive sections, highlight content trends, and/or improve formatting for downstream presentation).

The method 200, at block 208, includes generating, using the plurality of modified and/or updated content and the corresponding metadata, at least one output (e.g., structured, predefined elements such as categories and key trends, other sections, graphics, tables) based at least on a template. For example, the processing circuits can perform template filing and updating. The template can be a final newsletter template and/or schema. In some implementations, the template applied can be selected and/or determined based on content type (e.g., articles, reports, blog summaries), distribution format (e.g., for an email or via a mobile application), user preferences (e.g., preferred categories, presentation style), content ranking (e.g., priority news, high-engagement topics), and/or any dynamically generated organizational parameter.

The method 200, at block 210, includes providing, via an interface, the at least one structured output. In some implementations, the processing circuits can cause presentation of the at least one output. Causing can be facilitated and/or otherwise initiated by execution of rendering logic configured to retrieve, parse, and display the structured output on a client interface. That is, causing can include invoking display operations that transform the structured output into a presentable format based on the applied template. The interface can be any communication channel such as, via email, as a graphical user interface (GUI) on a mobile application, and/or via an application programming interface (API). For example, the structured output can be provided via an email to a group of users at an organization. In another example, the structured output can be provided as a GUI to a mobile application that can notify the users of the new structured output.

In some implementations, the at least one content source can correspond to a set of identifiers of at least one data source identified (e.g., identify a set of users, such as llama users, other AI relevant accounts, thought leaders) based at least on user activity data or a similarity metric to the at least one category. Additionally, determining the subset of a plurality of embeddings can be based on at least on using a fifth LM to process a plurality of relationships (e.g., semantic) between the plurality of embeddings and the at least one category. In some implementations, the processing circuits can be implemented in and/or as a component of an agent computing system (e.g., agent core). The agent computing system can be to obtain and model structured and unstructured data. The at least one data source can include a first data source accessed via a first data channel and a second data source accessed via a second data channel. That is, the processing circuits can obtain the social media posts and/or content from various social media sources.

The method 200 can include the processing circuits generating, using at least one second LM, the template based at least on at least one schema or at least one structure parameter corresponding with organizing the plurality of modified and/or updated content and the corresponding metadata. The schema can be a newsletter format corresponding to a predefined organizational framework and/or model defining how content and metadata are structured in the output. The structure parameter can be layout parameters, placement parameters, metadata associations, and/or any other look and feel parameters.

The method 200 can include the processing circuits updating the plurality of content records based at least on at least one of (i) a similarity threshold (e.g., redundant social media posts, such as greater than 98% similar) between at least two of the plurality of content records, or (ii) identifying attributes (e.g., PII data and/or other identifying data) in the plurality of content records. That is, the processing circuits can perform semantic de-duplication to remove redundant information and PII data.

The method 200 can include the processing circuits generating, using a curation model (e.g., NeMo curator), the plurality of embeddings of at least one segment of the plurality of content records based on at least one of (i) at least one textual element, (ii) at least one contextual attribute, (iii) metadata of the plurality of content records. The at least one segment can be a portion of the content or metadata of a social media post (e.g., hashtags, keywords, or links). The textual elements can be textual content within the content records (e.g., body of a social media post, associated captions, and/or extracted phrases from linked articles or blogs). The contextual attributes can be non-textual characteristics derived from the content itself and/or use case (e.g., category of the content, sentiment, popularity metric such as engagement levels (e.g., likes, shares, retweets)). The metadata can be static, descriptive data (e.g., timestamps, user IDs, source URLs, links to related articles).

The method 200 can include the processing circuits performing a meta-analysis. In some implementations, the processing circuits can obtain the plurality of embeddings corresponding with the plurality of content records and a plurality of structure outputs. That is, the processing circuits can obtain processed data and data previously stored in a newsletter database. Additionally, the processing circuits can generate, using the plurality of embeddings corresponding with the plurality of contents records and a plurality of structured outputs, a plurality of clusters (e.g., trend groups) based on at least one similarity metric. In some implementations, the processing circuits can apply the plurality of clusters as input to at least one third LM to cause the at least one third LM to generate at least one cluster representation (e.g., summarize the trend group). Additionally, the processing circuits can obtain additional content corresponding to the at least one cluster representation based on interfacing with a plurality of data sources. That is, the processing circuits can perform web searches and/or scrapes to gather additional information on the identified trends. In some implementations, the processing circuits can update (e.g., re-process the clustered information) the at least one cluster representation corresponding to at least one trend identified in the additional content. Additionally, the processing circuits can update a ranking function (e.g., use the found trends to improve the selection of relevant news) based on the at least one updated cluster representation. That is, the ranking function can be used in the ranking of the plurality of embeddings. In some implementations, the processing circuits can update (e.g., add summarized findings to the final newsletter) the at least one structured output based at least on the at least one updated cluster representation. That is, updating the at least one structured output can include at least one of (i) incorporating at least one summary of the additional content into the at least one structured output, or (ii) updating the corresponding metadata.

The method 200 can include the processing circuits performing interactions with one or more users. In some implementations, the processing circuits can receive, from a user device, a query (e.g., “What are the new LLMs related in the past 2 months?”; “Is there any recent agent news?”) corresponding to at least one of a plurality of structured outputs. Additionally, the processing circuits can generate an embedding of the query. In some implementations, the processing circuits can determine, based at least on the embedding, a filtered subset of the plurality of embeddings. Additionally, the processing circuits can apply the filtered subset of the plurality of embeddings as input to the at least one LM to cause the at least one LM to generate a response to the query. In some implementations, the processing circuits can provide, to the user device, the response to the query.

The method 200 can include the processing circuits performing personalization operations. In some implementations, the processing circuits can obtain a conversation cache (e.g., active conversations and/or recent conversations) and historical conversation data (e.g., historical conversations) based on interfacing with a plurality of data sources (e.g., internal and/or external). Additionally, the processing circuits can generate, using the conversation cache and the historical conversation data, a plurality of clusters (e.g., cluster user preferences) based at least on a preference similarity metric. In some implementations, the processing circuits can apply the plurality of clusters as input to at least one fourth LM to cause the at least one fourth LM to generate at least one cluster representation (e.g., summarize the user preferences). Additionally, the processing circuits can update a ranking function based on the at least one cluster representation, the ranking function used in the ranking of the plurality of embeddings.

Disclosed implementations can be included in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for using or deploying one or more inference microservices, systems for performing conversational AI operations, systems implementing one or more language models-such as one or more large language models (LLMs), one or more small language models (SLMs), systems for presenting at least one of virtual reality content, augmented reality content, or mixed reality content, one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

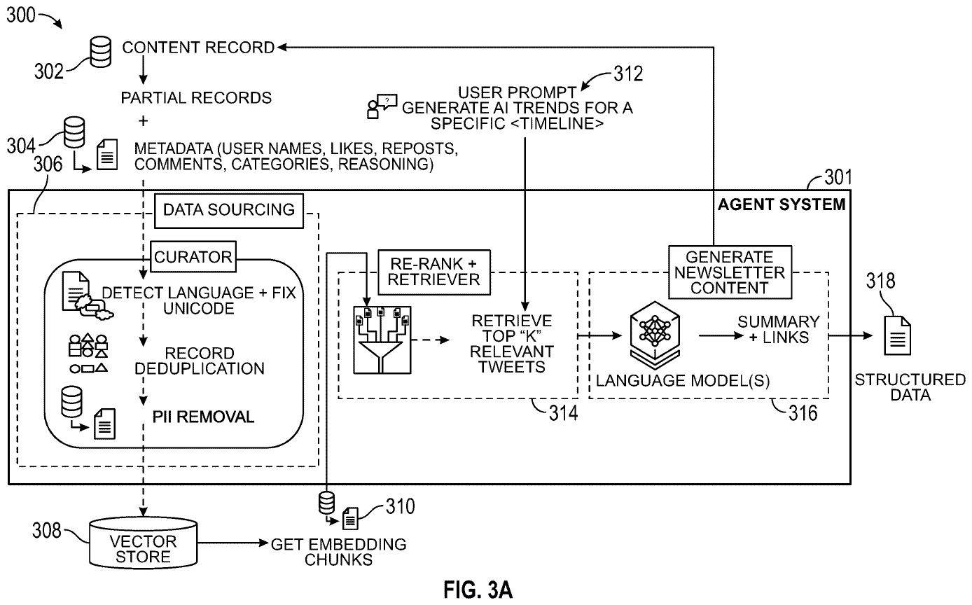

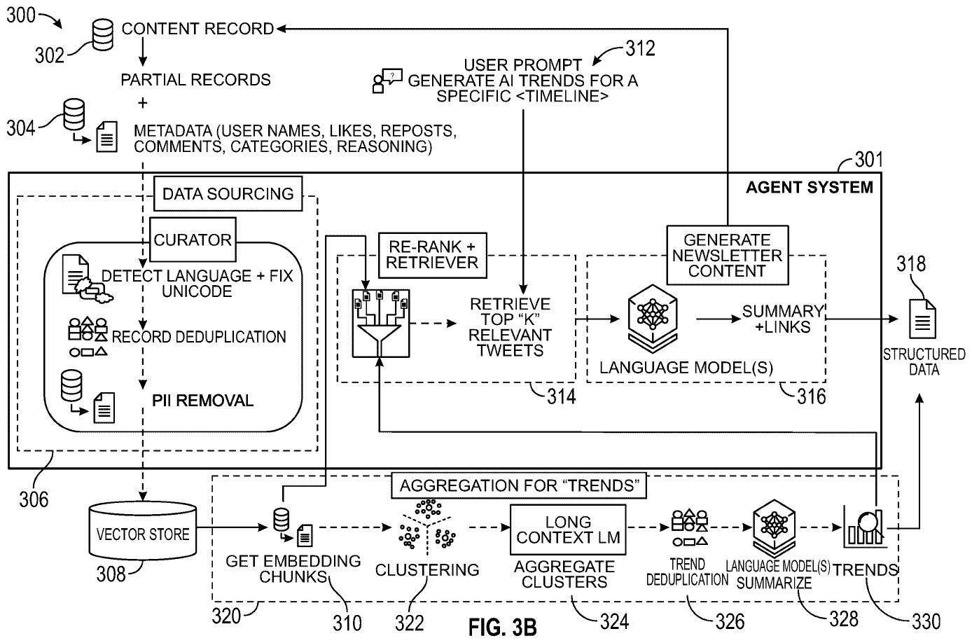

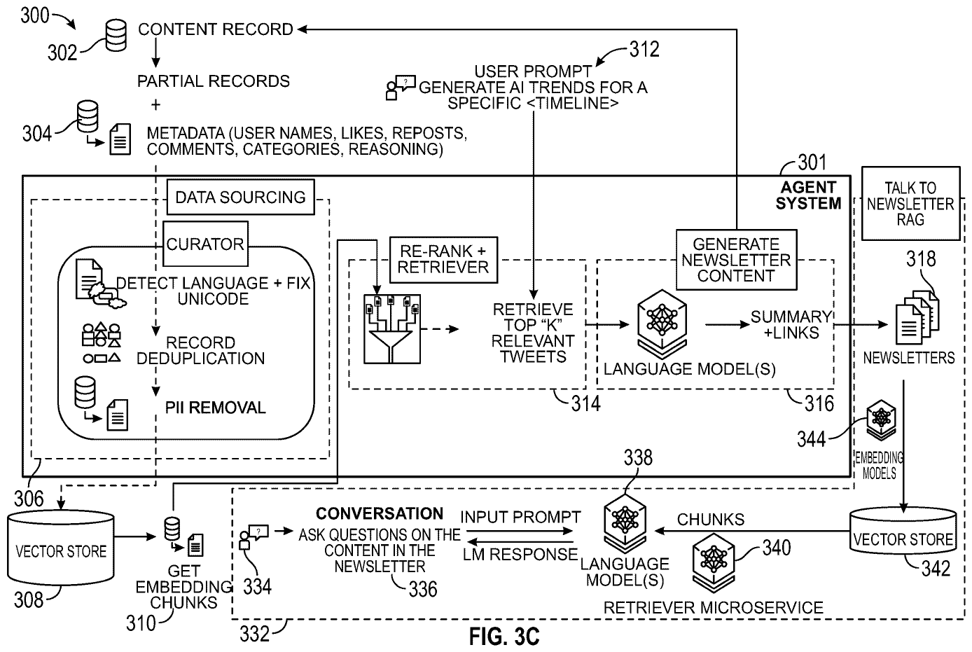

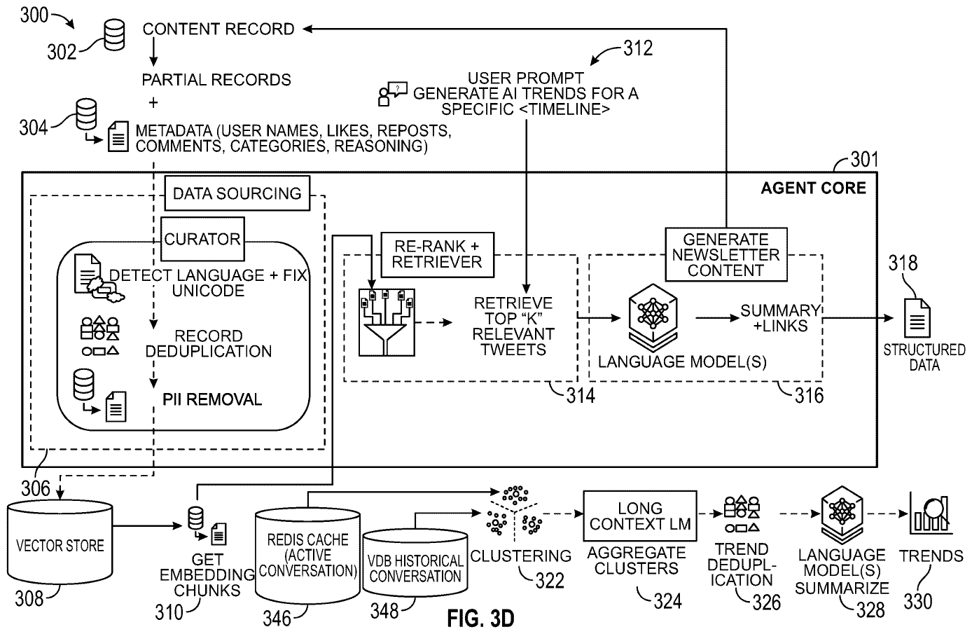

Referring now to FIG. 3A, an example illustrations of content modeling and structured output generation in a content curation pipeline 300, in accordance with some implementations of the present disclosure. In some implementations, agent system 301 (e.g., system 100 of FIG. 1, including similar features and functionalities) can process content records 302 (e.g., social media posts, articles) from at least one data source. The partial records and metadata 304 can be obtained and/or otherwise identified from the content records 302. The agent system 301 can include a data sourcing system 306 that applies a curator component to detect language inconsistencies (e.g., encoding errors, Unicode mismatches), perform record deduplication (e.g., identifying redundant posts with a similarity threshold), and/or remove personally identifiable information (PII) (e.g., user identifiers, profile metadata) on the partial records and metadata 304. The curated content can be stored in a vector store 308, where embeddings of the content records are generated. In some implementations, the agent system 301 can retrieve embedding chunks 310 from the vector store for further processing. The agent system 301 can apply a re-ranking and retrieval process 314 to select the top-K relevant records (e.g., tweets, posts, research articles) based on similarity metrics (e.g., cosine similarity, nearest neighbor search). A user prompt 312 can specify a request (e.g., generating AI trends for a specific timeline), triggering retrieval and/or ranking of content records aligned with the request. The retrieved content can be processed by at least one language model 316 (e.g., the model(s) 110 of FIG. 1) to generate structured content (e.g., summaries, extracted insights, link annotations). In some implementations, agent system 301 can generate at least one structured output 318 based on applying at least one template. The structured output 318 includes categorized summaries and metadata for downstream consumption (e.g., newsletters, reports, dashboards).

Referring now to FIG. 3B, an example illustrations of content modeling and structured output generation in a content curation pipeline 300, in accordance with some implementations of the present disclosure. In some implementations, the agent system 301 can process embeddings stored in a vector store (e.g., Qdrant, local storage) to generate aggregated trends (block 320). The agent system 301 can retrieve embedding chunks 310 from the vector store 308, and apply clustering 322 based on at least one similarity metric (e.g., cosine similarity, approximate nearest neighbor search). The clustered embeddings can be processed using a long-context language model (LM) (e.g., the model(s) 110 of FIG. 1) to generate aggregate clusters 324 representing grouped semantic relationships across content records. The aggregated clusters can be processed for trend deduplication 326 to remove redundant or semantically overlapping content. The agent system 301 can apply at least one language model (LM) (e.g., the model(s) 110 of FIG. 1) to summarize 328 the deduplicated content into trend representations. The generated trends 330 can be outputted for further processing and/or integrated into structured outputs, such as newsletters, reports, or dashboards (e.g., the structured output 318).

Referring now to FIG. 3C, an example illustrations of content modeling and structured output generation in a content curation pipeline 300, in accordance with some implementations of the present disclosure. In some implementations, the agent system 301 can facilitate user interaction (block 332) with structured outputs 318 (e.g., newsletters) using retrieval-augmented generation (RAG). A user 334 can submit a prompt corresponding to a query regarding structured outputs 318 (e.g., newsletters) through a conversation interface. That is, the user 334 can request information related to previously generated summaries, metadata, and/or embedded content. The conversation system (block 332) can process the user prompt 336 and provide the input prompt to language model(s) 338 (e.g., the model(s) 110 of FIG. 1). The language model(s) 338 can generate an initial response and/or process the input prompt to retrieve relevant stored embeddings from vector store 342 (e.g., chunks). The language model(s) 338 can interface with a retriever microservice 340 to obtain relevant content chunks corresponding to the query. That is, the retriever microservice 340 can retrieve semantically similar content representations from vector store 342 based on similarity metrics (e.g., cosine similarity, approximate nearest neighbor (ANN) search). The retrieved chunks can be passed back to the language model(s) 338, which processes the retrieved content embeddings and refines the generated response based on both stored information and pretrained knowledge.

In some implementations, the final response can be returned to the conversation system (block 332) and provided to the user 334 as an LM response. The structured outputs 318 can be indexed in the vector store 342 using embedding models 344 to allow retrieval and ranking of the most relevant information in response to queries. The retrieval and response generation processes can be updated dynamically based on new structured outputs and user interactions. Additionally, the vector store 342 can store indexed embeddings of structured outputs 318 (e.g., newsletters) to facilitate content retrieval based on similarity metrics. The retrieval process can include applying ranking models to prioritize the most relevant embeddings based on the user prompt 336. In some implementations, the language model(s) 338 can generate responses by re-ranking retrieved results, and applying contextual inference. Additionally, the language model(s) 338 can integrate real-time query refinement, updating the retrieved content based on iterative user interactions. The structured outputs 318 can be periodically updated in the vector store 342 using the embedding models 344 to reflect newly generated newsletters and structured content.

In some implementations, agent system 301 can implement embedding models 344 to convert structured outputs 318 (e.g., newsletters) into vector representations stored in vector store 342. The embedding models 344 can process textual content, metadata, and/or other structural elements to generate numerical embeddings that preserve semantic relationships within the content. That is, the embedding models 344 can map sections of structured outputs 318 into fixed-length vector representations that facilitate similarity-based retrieval. For example, at least one (e.g., each) structured output 318 (e.g., newsletter) can be processed into multiple embedding chunks, where each chunk corresponds to different sections such as summaries, headlines, metadata fields, and extracted key phrases. Additionally, the embedding models 344 can include transformer-based models, recurrent neural networks (RNNs), and/or specialized sentence encoders that project the content into a latent space optimized for retrieval tasks. The embeddings stored in vector store 342 can be queried using similarity search techniques. The embeddings generated by embedding models 344 can be dynamically updated as new structured outputs 318 are added to the agent system 301 (e.g., system 100).

Referring now to FIG. 3D, an example illustrations of content modeling and structured output generation in a content curation pipeline 300, in accordance with some implementations of the present disclosure. In some implementations, the agent system 301 can generate personalized structured outputs by incorporating user interaction data. The agent system 301 can retrieve embeddings (e.g., chunks 310) from the vector store 308, and obtain active conversation data from a Redis cache 346 (and/or any other cache) and historical conversation data from a VDB historical conversation store 348 (and/or any other database or storage system). The retrieved embeddings and conversation data can be processed using clustering 322 to form groupings based on at least one preference similarity metric. The clustered data can be processed by a long-context LM (e.g., the model(s) 110 of FIG. 1) to generate aggregate clusters 324 representing user-specific topics or discussions. Trend deduplication 326 can be applied to remove redundant or highly similar content. The agent system 301 can apply at least one language model (LM) (e.g., the model(s) 110 of FIG. 1) to summarize 328 the deduplicated trends, and generate personalized insights. The generated trends 330 can be used to refine ranking functions, personalize structured outputs, and/or provide responses to user queries.

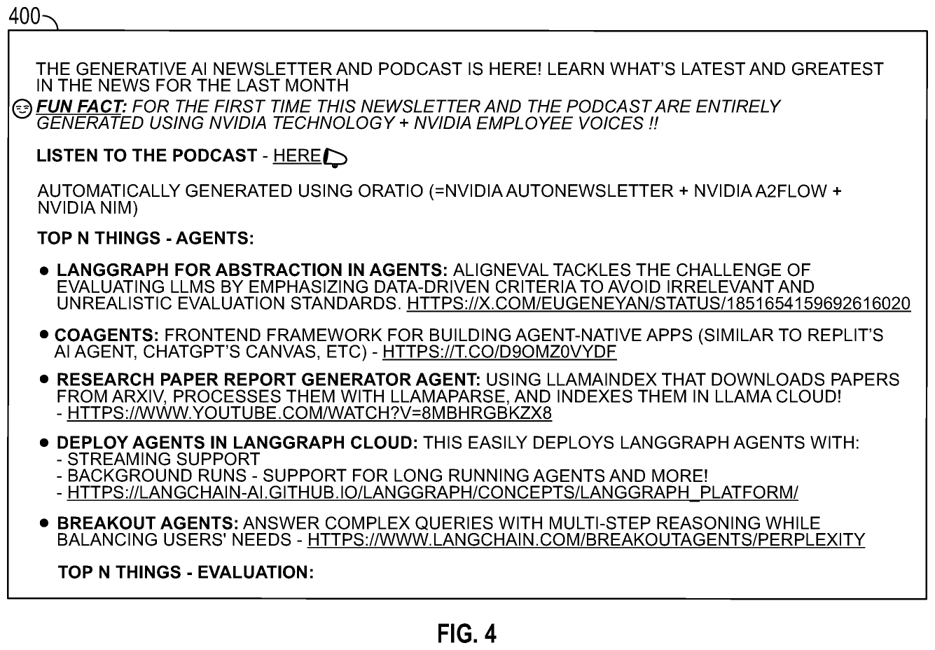

Referring to FIG. 4, an example interface 400 corresponding to a structured output, in accordance with some implementations of the present disclosure. In some implementations, system 100 can generate a structured output 114 which can be presented in an interface 400. The interface 400 can be an email, a graphical user interface (GUI), an output provided via an application programming interface (API), and/or any other interface. The structured output 114 can be formatted according to predefined templates that organize summarized content and corresponding metadata extracted from various data sources. That is, the structured output 114 can include sections corresponding to categorized content, such as “TOP N THINGS—AGENTS” and “TOP N THINGS—EVALUATION,” where at least one (e.g., each) section can include ranked summaries of news, research, and/or developments related to the respective category. In some implementations, the structured output 114 can be generated based on applying embeddings to language model(s) 110 to output condensed summaries of retrieved content. For example, a summary of an agent-based framework (e.g., “LANGGRAPH FOR ABSTRACTION IN AGENTS”) can be extracted from curated sources, processed into a headline and description, and/or associated with relevant metadata such as links (e.g., social media posts, research papers, official documentation). The structured output 114 can also incorporate call-to-action elements (e.g., “LISTEN TO THE PODCAST—HERE”) and supplementary metadata (e.g., automatically generated identifiers, publication timestamps). In some implementations, system 100 can dynamically update the structured output 114 by modifying rankings, integrating newly retrieved content, and/or incorporating trend-based insights extracted during processing stages.

### Example Language Models

In at least some implementations, language models, such as large language models (LLMs), small language models (SLMs), vision language models (VLMs), multi-modal language models (MMLMs), and/or other types of generative artificial intelligence (AI) can be implemented. Generally, the language models can process embeddings derived from content records, generate summarized and headline content, refine structured outputs based on ranking functions, and/or facilitate retrieval-augmented generation (RAG) for context-aware responses. These models can be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models can be considered “large,” in implementations, based on the models being trained on massive datasets and having architectures with large number of learnable network parameters (weights and biases)—such as millions or billions of parameters. The LLMs/SLMs/VLMs/MMLMs/etc. can be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure can be used exclusively for text processing, in implementations, whereas in other implementations, multi-modal LLMs can be implemented to accept, understand, and/or generate text and/or other types of content like images, audio, 2D and/or 3D data (e.g., in USD formats), and/or video. For example, vision language models (VLMs), or more generally multi-modal language models (MMLMs), can be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures can be implemented in various implementations. For example, different architectures can be implemented that use different techniques for understanding and generating outputs—such as text, audio, video, image, 2D and/or 3D design or asset data, etc. In some implementations, LLMs/SLMs/VLMs/MMLMs/etc. architectures such as recurrent neural networks (RNNs) or long short-term memory networks (LSTMs) can be used, while in other implementations transformer architectures—such as those that rely on self-attention and/or cross-attention (e.g., between contextual data and textual data) mechanisms—can be used to understand and recognize relationships between words or tokens and/or contextual data (e.g., other text, video, image, design data, USD, etc.). One or more generative processing pipelines that include LLMs/SLMs/VLMs/MMLMs/etc. can also include one or more diffusion block(s) (e.g., denoisers). The LLMs/SLMs/VLMs/MMLMs/etc. of the present disclosure can include encoder and/or decoder block(s). For example, discriminative or encoder-only models like BERT (Bidirectional Encoder Representations from Transformers) can be implemented for tasks that involve language comprehension such as classification, sentiment analysis, question answering, and named entity recognition. As another example, generative or decoder-only models like GPT (Generative Pretrained Transformer) can be implemented for tasks that involve language and content generation such as text completion, story generation, and dialogue generation. LLMs/SLMs/VLMs/MMLMs/etc. that include both encoder and decoder components like T5 (Text-to-Text Transformer) can be implemented to understand and generate content, such as for translation and summarization. These examples are not intended to be limiting, and any architecture type—including but not limited to those described herein—can be implemented depending on the particular implementation and the task(s) being performed using the LLMs/SLMs/VLMs/MMLMs/etc.

In various implementations, the LLMs/SLMs/VLMs/MMLMs/etc. can be trained using unsupervised learning, in which an LLMs/SLMs/VLMs/MMLMs/etc. learns patterns from large amounts of unlabeled text/audio/video/image/design/USD/etc. data. Due to the extensive training, in implementations, the models cannot require task-specific or domain-specific training. LLMs/SLMs/VLMs/MMLMs/etc. that have undergone extensive pre-training on vast amounts of unlabeled data can be referred to as foundation models and can be adept at a variety of tasks like question-answering, summarization, filling in missing information, translation, image/video/design/USD/data generation. Some LLMs/SLMs/VLMs/MMLMs/etc. can be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some implementations, the LLMs/SLMs/VLMs/MMLMs/etc. of the present disclosure can be implemented using various model alignment techniques. For example, in some implementations, guardrails can be implemented to identify improper or undesired inputs (e.g., prompts) and/or outputs of the models. In doing so, the system can use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some implementations, one or more additional models—or layers thereof—can be implemented to identify issues with inputs and/or outputs of the models. For example, these “safeguard” models can be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure can be less likely to output language/text/audio/video/design data/USD data/etc. that can be offensive, vulgar, improper, unsafe, out of domain, and/or otherwise undesired for the particular application/implementation.

In some implementations, the LLMs/SLMs/VLMs/etc. can be to or capable of accessing or using one or more plug-ins, application programming interfaces (APIs), databases, data stores, repositories, etc. For example, for certain tasks or operations that the model is not ideally suited for, the model can have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model can access one or more restaurant or weather plug-ins (e.g., via one or more APIs) to retrieve the relevant information. As another example, where at least part of a response requires a mathematical computation, the model can access one or more math plug-ins or APIs for help in solving the problem(s), and can then use the response from the plug-in and/or API in the output from the model. This process can be repeated—e.g., recursively—for any number of iterations and using any number of plug-ins and/or APIs until a response to the input prompt can be generated that addresses each ask/question/request/process/operation/etc. As such, the model(s) can not only rely on its own knowledge from training on a large dataset(s), but also on the expertise or optimized nature of one or more external resources—such as APIs, plug-ins, and/or the like.

In some implementations, multiple language models (e.g., LLMs/SLMs/VLMs/MMLMs/etc., multiple instances of the same language model, and/or multiple prompts provided to the same language model or instance of the same language model can be implemented, executed, or accessed (e.g., using one or more plug-ins, user interfaces, APIs, databases, data stores, repositories, etc.) to provide output responsive to the same query, or responsive to separate portions of a query. In at least one implementation, multiple language models e.g., language models with different architectures, language models trained on different (e.g., updated) corpuses of data can be provided with the same input query and prompt (e.g., set of constraints, conditioners, etc.). In one or more implementations, the language models can be different versions of the same foundation model. In one or more implementations, at least one language model can be instantiated as multiple agents—e.g., more than one prompt can be provided to constrain, direct, or otherwise influence a style, a content, or a character, etc., of the output provided. In one or more example, non-limiting implementations, the same language model can be asked to provide output corresponding to a different role, perspective, character, or having a different base of knowledge, etc.—as defined by a supplied prompt.

In any one of such implementations, the output of two or more (e.g., each) language models, two or more versions of at least one language model, two or more instanced agents of at least one language model, and/or two more prompts provided to at least one language model can be further processed, e.g., aggregated, compared or filtered against, or used to determine (and provide) a consensus response. In one or more implementations, the output from one language model—or version, instance, or agent—can be provided as input to another language model for further processing and/or validation. In one or more implementations, a language model can be asked to generate or otherwise obtain an output with respect to an input source material, with the output being associated with the input source material. Such an association can include, for example, the generation of a caption or portion of text that is embedded (e.g., as metadata) with an input source text or image. In one or more implementations, an output of a language model can be used to determine the validity of an input source material for further processing, or inclusion in a dataset. For example, a language model can be used to assess the presence (or absence) of a target word in a portion of text or an object in an image, with the text or image being annotated to note such presence (or lack thereof). Alternatively, the determination from the language model can be used to determine whether the source material should be included in a curated dataset, for example and without limitation.

FIG. 5A is a block diagram of an example generative language model system 500 suitable for use in implementing at least some implementations of the present disclosure. Generally, the example generative language model system 500 can process embeddings derived from content records, generate summarized and headline content, refine structured outputs based on ranking functions, and/or facilitate retrieval-augmented generation (RAG) for context-aware responses. In the example illustrated in FIG. 5A, the generative language model system 500 includes a retrieval augmented generation (RAG) component 592, an input processor 505, a tokenizer 510, an embedding component 520, plug-ins/APIs 595, and a generative language model (LM) 530 (which can include an LLM, a SLM, a VLM, a multi-modal LM, etc.).

At a high level, the input processor 505 can receive an input 501 including text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 530 (e.g., LLM/SLM/VLM/MMLM/etc.). In some implementations, the input 501 includes plain text in the form of one or more sentences, paragraphs, and/or documents. Additionally, or alternatively, the input 501 can include numerical sequences, precomputed embeddings (e.g., word or sentence embeddings), and/or structured data (e.g., in tabular formats, JSON, or XML). In some implementations in which the generative LM 530 is capable of processing multi-modal inputs, the input 501 can combine text (or can omit text) with image data, audio data, video data, design data, USD data, and/or other types of input data, such as but not limited to those described herein. Taking raw input text as an example, the input processor 505 can prepare raw input text in various ways. For example, the input processor 505 can perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 505 can remove stopwords to reduce noise and focus the generative LM 530 on more meaningful content. The input processor 505 can apply text normalization, for example, by converting all characters to lowercase, removing accents, and/or or handling special cases like contractions or abbreviations to ensure consistency. These are just a few examples, and other types of input processing can be applied.

In some implementations, a RAG component 592 (which can include one or more RAG models, and/or can be performed using the generative LM 530 itself) can be used to retrieve additional information to be used as part of the input 501 or prompt. RAG can be used to enhance the input to the LLM/SLM/VLM/MMLM/etc. with external knowledge, so that answers to specific questions or queries or requests are more relevant—such as in a case where specific knowledge is required. The RAG component 592 can fetch this additional information (e.g., grounding information, such as grounding text/image/video/audio/USD/CAD/etc.) from one or more external sources, which can then be fed to the LLM/SLM/VLM/MMLM/etc. along with the prompt to improve accuracy of the responses or outputs of the model.

For example, in some implementations, the input 501 can be generated using the query or input to the model (e.g., a question, a request, etc.) in addition to data retrieved using the RAG component 592. In some implementations, the input processor 505 can analyze the input 501 and communicate with the RAG component 592 (or the RAG component 592 can be part of the input processor 505, in implementations) in order to identify relevant text and/or other data to provide to the generative LM 530 as additional context or sources of information from which to identify the response, answer, or output 590, generally. For example, where the input indicates that the user is interested in a desired tire pressure for a particular make and model of vehicle, the RAG component 592 can retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 592 can retrieve a prior stored conversation history—or at least a summary thereof—and include the prior conversation history along with the current ask/request as part of the input 501 to the generative LM 530.

The RAG component 592 can use various RAG techniques. For example, naïve RAG can be used where documents are indexed, chunked, and applied to an embedding model to generate embeddings corresponding to the chunks. A user query can also be applied to the embedding model and/or another embedding model of the RAG component 592 and the embeddings of the chunks along with the embeddings of the query can be compared to identify the most similar/related embeddings to the query, which can be supplied to the generative LM 530 to generate an output.

In some implementations, more advanced RAG techniques can be used. For example, prior to passing chunks to the embedding model, the chunks can undergo pre-retrieval processes (e.g., routing, rewriting, metadata analysis, expansion, etc.). In addition, prior to generating the final embeddings, post-retrieval processes (e.g., re-ranking, prompt compression, etc.) can be performed on the outputs of the embedding model prior to final embeddings being used as comparison to an input query.

As a further example, modular RAG techniques can be used, such as those that are similar to naïve and/or advanced RAG, but also include features such as hybrid search, recursive retrieval and query engines, StepBack approaches, sub-queries, and hypothetical document embedding.

As another example, Graph RAG can use knowledge graphs as a source of context or factual information. Graph RAG can be implemented using a graph database as a source of contextual information sent to the LLM/SLM/VLM/MMLM/etc. Rather than (or in addition to) providing the model with chunks of data extracted from larger sized documents—which can result in a lack of context, factual correctness, language accuracy, etc.—graph RAG can also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such implementations, can contain relevant textual content and metadata about the knowledge graph as well as be integrated with a vector database. In some implementations, the graph RAG can use a graph as a subject matter expert, where descriptions of concepts and entities relevant to a query/prompt can be extracted and passed to the model as semantic context. These descriptions can include relationships between the concepts. In other examples, the graph can be used as a database, where part of a query/prompt can be mapped to a graph query, the graph query can be executed, and the LLM/SLM/VLM/MMLM/etc. can summarize the results. In such an example, the graph can store relevant factual information, and a query (natural language query) to graph query tool (NL-to-Graph-query tool) and entity linking can be used. In some implementations, graph RAG (e.g., using a graph database) can be combined with standard (e.g., vector database) RAG, and/or other RAG types, to benefit from multiple approaches.

In any implementations, the RAG component 592 can implement a plugin, API, user interface, and/or other functionality to perform RAG. For example, a graph RAG plug-in can be used by the LLM/SLM/VLM/MMLM/etc. to run queries against the knowledge graph to extract relevant information for feeding to the model, and a standard or vector RAG plug-in can be used to run queries against a vector database. For example, the graph database can interact with a REST interface plug-in such that the graph database is decoupled from the vector database and/or the embeddings models.

The tokenizer 510 can segment the (e.g., processed) text data into smaller units (tokens) for subsequent analysis and processing. The tokens can represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 530 to understand morphological variations and handle out-of-vocabulary words more effectively. Character-based tokenization represents each character as a separate token, enabling the generative LM 530 to process text at a fine-grained level. The choice of tokenization strategy can depend on factors such as the language being processed, the task at hand, and/or characteristics of the training dataset. As such, the tokenizer 510 can convert the (e.g., processed) text into a structured format according to tokenization schema being implemented in the particular implementation.

The embedding component 520 can use any known embedding technique to transform discrete tokens into (e.g., dense, continuous vector) representations of semantic meaning. For example, the embedding component 520 can use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 501 includes image data/video data/etc., the input processor 505 can resize the data to a standard size compatible with format of a corresponding input channel and/or can normalize pixel values to a common range (e.g., 0 to 1) to ensure a consistent representation, and the embedding component 520 can encode the image data using any known technique (e.g., using one or more convolutional neural networks (CNNs) to extract visual features). In some implementations in which the input 501 includes audio data, the input processor 505 can resample an audio file to a consistent sampling rate for uniform processing, and the embedding component 520 can use any known technique to extract and encode audio features—such as in the form of a spectrogram (e.g., a mel-spectrogram). In some implementations in which the input 501 includes video data, the input processor 505 can extract frames or apply resizing to extracted frames, and the embedding component 520 can extract features such as optical flow embeddings or video embeddings and/or can encode temporal information or sequences of frames. In some implementations in which the input 501 includes multi-modal data, the embedding component 520 can fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 530 and/or other components of the generative LM system 500 can use different types of neural network architectures depending on the implementation. For example, transformer-based architectures such as those used in models like GPT can be implemented, and can include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 520 can apply an encoded representation of the input 501 to the generative LM 530, and the generative LM 530 can process the encoded representation of the input 501 to generate an output 590, which can include responsive text and/or other types of data.

As described herein, in some implementations, the generative LM 530 can be to access or use—or capable of accessing or using—plug-ins/APIs 595 (which can include one or more plug-ins, application programming interfaces (APIs), databases, data stores, repositories, etc.). For example, for certain tasks or operations that the generative LM 530 is not ideally suited for, the model can have instructions (e.g., as a result of training, and/or based on instructions in a given prompt, such as those retrieved using the RAG component 592) to access one or more plug-ins/APIs 595 (e.g., 3^{rd} party plugins) for help in processing the current input. In such an example, where at least part of a prompt is related to restaurants or weather, the model can access one or more restaurant or weather plug-ins (e.g., via one or more APIs), send at least a portion of the prompt related to the particular plug-in/API 595 to the plug-in/API 595, the plug-in/API 595 can process the information and return an answer to the generative LM 530, and the generative LM 530 can use the response to generate the output 590. This process can be repeated—e.g., recursively—for any number of iterations and using any number of plug-ins/APIs 595 until an output 590 that addresses each ask/question/request/process/operation/etc. from the input 501 can be generated. As such, the model(s) can not only rely on its own knowledge from training on a large dataset(s) and/or from data retrieved using the RAG component 592, but also on the expertise or optimized nature of one or more external resources—such as the plug-ins/APIs 595.

FIG. 5B is a block diagram of an example implementation in which the generative LM 530 includes a transformer encoder-decoder. Generally, the generative LM 530 can process embeddings derived from content records, generate summarized and headline content, refine structured outputs based on ranking functions, and/or facilitate retrieval-augmented generation (RAG) for context-aware responses. For example, assume input text such as “Who discovered gravity” is tokenized (e.g., by the tokenizer 510 of FIG. 5A) into tokens such as words, and each token is encoded (e.g., by the embedding component 520 of FIG. 5A) into a corresponding embedding (e.g., of size 512). Since these token embeddings typically do not represent the position of the token in the input sequence, any known technique can be used to add a positional encoding to each token embedding to encode the sequential relationships and context of the tokens in the input sequence. As such, the (e.g., resulting) embeddings can be applied to one or more encoder(s) 535 of the generative LM 530.

In an example implementation, the encoder(s) 535 forms an encoder stack, where each encoder includes a self-attention layer and a feedforward network. In an example transformer architecture, each token (e.g., word) flows through a separate path. As such, each encoder can accept a sequence of vectors, passing each vector through the self-attention layer, then the feedforward network, and then upwards to the next encoder in the stack. Any known self-attention technique can be used. For example, to calculate a self-attention score for each token (word), a query vector, a key vector, and a value vector can be created for each token, a self-attention score can be calculated for pairs of tokens by taking the dot product of the query vector with the corresponding key vectors, normalizing the resulting scores, multiplying by corresponding value vectors, and summing weighted value vectors. The encoder can apply multi-headed attention in which the attention mechanism is applied multiple times in parallel with different learned weight matrices. Any number of encoders can be cascaded to generate a context vector encoding the input. An attention projection layer 540 can convert the context vector into attention vectors (keys and values) for the decoder(s) 545.

In an example implementation, the decoder(s) 545 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 535, in an example transformer architecture, each token (e.g., word) flows through a separate path in the decoder(s) 545. During a first pass, the decoder(s) 545, a classifier 550, and a generation mechanism 555 can generate a first token, and the generation mechanism 555 can apply the generated token as an input during a second pass. The process can repeat in a loop, successively generating and adding tokens (e.g., words) to the output from the preceding pass, and applying the token embeddings of the composite sequence with positional encodings as an input to the decoder(s) 545 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 535, except that it creates its queries from the layer below it and takes the keys and values (e.g., matrix) from the output of the encoder(s) 535.

As such, the decoder(s) 545 can output some decoded (e.g., vector) representation of the input being applied during a particular pass. The classifier 550 can include a multi-class classifier including one or more neural network layers that project the decoded (e.g., vector) representation into a corresponding dimensionality (e.g., one dimension for each supported word or token in the output vocabulary) and a softmax operation that converts logits to probabilities. As such, the generation mechanism 555 can select or sample a word or token based on a corresponding predicted probability (e.g., select the word with the highest predicted probability), and append it to the output from a previous pass, generating each word or token sequentially. The generation mechanism 555 can repeat the process, triggering successive decoder inputs and corresponding predictions until selecting or sampling a symbol or token that represents the end of the response, at which point, the generation mechanism 555 can output the generated response.

FIG. 5C is a block diagram of an example implementation in which the generative LM 530 includes a decoder-only transformer architecture. For example, the decoder(s) 560 of FIG. 5C can operate similarly as the decoder(s) 545 of FIG. 5B except each of the decoder(s) 560 of FIG. 5C omits the encoder-decoder self-attention layer (since there is no encoder in this implementation). As such, the decoder(s) 560 can form a decoder stack, where each decoder includes a self-attention layer and a feedforward network. In some implementations, instead of encoding the input sequence, a symbol or token representing the end of the input sequence (or the beginning of the output sequence) can be appended to the input sequence, and the resulting sequence (e.g., corresponding embeddings with positional encodings) can be applied to the decoder(s) 560. As with the decoder(s) 545 of FIG. 5B, each token (e.g., word) can flow through a separate path in the decoder(s) 560, and the decoder(s) 560, a classifier 565, and a generation mechanism 570 can use auto-regression to sequentially generate one token at a time until predicting a symbol or token that represents the end of the response. The classifier 565 and the generation mechanism 570 can operate similarly as the classifier 550 and the generation mechanism 555 of FIG. 5B, with the generation mechanism 570 selecting or sampling each successive output token based on a corresponding predicted probability, and appending it to the output from a previous pass, generating each token sequentially until selecting or sampling a symbol or token that represents the end of the response. Generally, the generative LM 530 can process embeddings derived from content records, generate summarized and headline content, refine structured outputs based on ranking functions, and/or facilitate retrieval-augmented generation (RAG) for context-aware responses. These and other architectures described herein are meant simply as examples, and other suitable architectures can be implemented within the scope of the present disclosure.

### Example Computing Device

FIG. 6 is a block diagram of an example computing device(s) 600 suitable for use in implementing some implementations of the present disclosure. Generally, the example computing device(s) 600 can process, store, and transmit data, execute machine learning models, and facilitate interactions with various components of the content curation pipeline. Computing device 600 can include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one implementation, the computing device(s) 600 can include one or more virtual machines (VMs), and/or any of the components thereof can include virtual components (e.g., virtual hardware components). For non-limiting examples, one or more of the GPUs 608 can include one or more vGPUs, one or more of the CPUs 606 can include one or more vCPUs, and/or one or more of the logic units 620 can include one or more virtual logic units. As such, a computing device(s) 600 can include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some implementations, a presentation component 618, such as a display device, can be considered an I/O component 614 (e.g., if the display is a touch screen). As another example, the CPUs 606 and/or GPUs 608 can include memory (e.g., the memory 604 can be representative of a storage device in addition to the memory of the GPUs 608, the CPUs 606, and/or other components). As such, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 can represent one or more links or busses, such as an address bus, a data bus, a control bus, or a combination thereof. The interconnect system 602 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 606 can be directly connected to the memory 604. Further, the CPU 606 can be directly connected to the GPU 608. Where there is direct, or point-to-point connection between components, the interconnect system 602 can include a PCIe link to carry out the connection. In these examples, a PCI bus need not be included in the computing device 600.

The memory 604 can include any of a variety of computer-readable media. The computer-readable media can be any available media that can be accessed by the computing device 600. The computer-readable media can include both volatile and nonvolatile media, and removable and non-removable media. By way of example, and not limitation, the computer-readable media can include computer-storage media and communication media.

The computer-storage media can include both volatile and nonvolatile media and/or removable and non-removable media implemented in any method or technology for storage of information such as computer-readable instructions, data structures, program modules, and/or other data types. For example, the memory 604 can store computer-readable instructions (e.g., that represent a program(s) and/or a program element(s), such as an operating system. Computer-storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information, and which can be accessed by computing device 600. As used herein, computer storage media does not include signals per se.

The computer storage media can embody computer-readable instructions, data structures, program modules, and/or other data types in a modulated data signal such as a carrier wave or other transport mechanism and includes any information delivery media. The term “modulated data signal” can refer to a signal that has one or more of its characteristics set or changed in such a manner as to encode information in the signal. By way of example, and not limitation, the computer storage media can include wired media such as a wired network or direct-wired connection, and wireless media such as acoustic, RF, infrared and other wireless media. Combinations of any of the above should also be included within the scope of computer-readable media.

The CPU(s) 606 can be to execute at least some of the computer-readable instructions to control one or more components of the computing device 600 to perform one or more of the methods and/or processes described herein. The CPU(s) 606 can each include one or more cores (e.g., one, two, four, eight, twenty-eight, seventy-two, etc.) that are capable of handling a multitude of software threads simultaneously. The CPU(s) 606 can include any type of processor, and can include different types of processors depending on the type of computing device 600 implemented (e.g., processors with fewer cores for mobile devices and processors with more cores for servers). For example, depending on the type of computing device 600, the processor can be an Advanced RISC Machines (ARM) processor implemented using Reduced Instruction Set Computing (RISC) or an x86 processor implemented using Complex Instruction Set Computing (CISC). The computing device 600 can include one or more CPUs 606 in addition to one or more microprocessors or supplementary co-processors, such as math co-processors.

In addition to or alternatively from the CPU(s) 606, the GPU(s) 608 can be to execute at least some of the computer-readable instructions to control one or more components of the computing device 600 to perform one or more of the methods and/or processes described herein. One or more of the GPU(s) 608 can be an integrated GPU (e.g., with one or more of the CPU(s) 606 and/or one or more of the GPU(s) 608 can be a discrete GPU. In implementations, one or more of the GPU(s) 608 can be a coprocessor of one or more of the CPU(s) 606. The GPU(s) 608 can be used by the computing device 600 to render graphics (e.g., 3D graphics) or perform general purpose computations. For example, the GPU(s) 608 can be used for General-Purpose computing on GPUs (GPGPU). The GPU(s) 608 can include hundreds or thousands of cores that are capable of handling hundreds or thousands of software threads simultaneously. The GPU(s) 608 can generate pixel data for output images in response to rendering commands (e.g., rendering commands from the CPU(s) 606 received via a host interface). The GPU(s) 608 can include graphics memory, such as display memory, for storing pixel data or any other suitable data, such as GPGPU data. The display memory can be included as part of the memory 604. The GPU(s) 608 can include two or more GPUs operating in parallel (e.g., via a link). The link can directly connect the GPUs (e.g., using NVLINK) or can connect the GPUs through a switch (e.g., using NVSwitch). When combined together, each GPU 608 can generate pixel data or GPGPU data for different portions of an output or for different outputs (e.g., a first GPU for a first image and a second GPU for a second image). Each GPU can include its own memory, or can share memory with other GPUs.

In addition to or alternatively from the CPU(s) 606 and/or the GPU(s) 608, the logic unit(s) 620 can be to execute at least some of the computer-readable instructions to control one or more components of the computing device 600 to perform one or more of the methods and/or processes described herein. In implementations, the CPU(s) 606, the GPU(s) 608, and/or the logic unit(s) 620 can discretely or jointly perform any combination of the methods, processes and/or portions thereof. One or more of the logic units 620 can be part of and/or integrated in one or more of the CPU(s) 606 and/or the GPU(s) 608 and/or one or more of the logic units 620 can be discrete components or otherwise external to the CPU(s) 606 and/or the GPU(s) 608. In implementations, one or more of the logic units 620 can be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which can include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 can include one or more receivers, transmitters, and/or transceivers that allow the computing device 600 to communicate with other computing devices via an electronic communication network, included wired and/or wireless communications. The communication interface 610 can include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 620 and/or communication interface 610 can include one or more data processing units (DPUs) to transmit data received over a network and/or through interconnect system 602 directly to (e.g., a memory of) one or more GPU(s) 608.

The I/O ports 612 can allow the computing device 600 to be logically coupled to other devices including the I/O components 614, the presentation component(s) 618, and/or other components, some of which can be built in to (e.g., integrated in) the computing device 600. Illustrative I/O components 614 include a microphone, mouse, keyboard, joystick, game pad, game controller, satellite dish, scanner, printer, wireless device, etc. The I/O components 614 can provide a natural user interface (NUI) that processes air gestures, voice, or other physiological inputs generated by a user. In some instances, inputs can be transmitted to an appropriate network element for further processing. An NUI can implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 can be include depth cameras, such as stereoscopic camera systems, infrared camera systems, RGB camera systems, touchscreen technology, and combinations of these, for gesture detection and recognition. Additionally, the computing device 600 can include accelerometers or gyroscopes (e.g., as part of an inertia measurement unit (IMU)) that allow detection of motion. In some examples, the output of the accelerometers or gyroscopes can be used by the computing device 600 to render immersive augmented reality or virtual reality.

The power supply 616 can include a hard-wired power supply, a battery power supply, or a combination thereof. The power supply 616 can provide power to the computing device 600 to allow the components of the computing device 600 to operate.

The presentation component(s) 618 can include a display (e.g., a monitor, a touch screen, a television screen, a heads-up-display (HUD), other display types, or a combination thereof), speakers, and/or other presentation components. The presentation component(s) 618 can receive data from other components (e.g., the GPU(s) 608, the CPU(s) 606, DPUs, etc.), and output the data (e.g., as an image, video, sound, etc.).

### Example Data Center

FIG. 7 illustrates an example data center 700 that can be used in at least one implementations of the present disclosure. Generally, the example data center 700 can computational and/or storage resources, manage distributed processing tasks, and/or support large-scale data storage and retrieval operations for content analysis, ranking, and/or structured output generation. The data center 700 can include a data center infrastructure layer 710, a framework layer 720, a software layer 730, and/or an application layer 740.

As shown in FIG. 7, the data center infrastructure layer 710 can include a resource orchestrator 712, grouped computing resources 714, and node computing resources (“node C.R.s”) 716(1)-716(N), where “N” represents any whole, positive integer. In at least one implementation, node C.R.s 716(1)-716(N) can include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R. s from among node C.R.s 716(1)-716(N) can correspond to a server having one or more of the above-mentioned computing resources. In addition, in some implementations, the node C.R.s 716(1)-7161(N) can include one or more virtual components, such as vGPUs, vCPUs, and/or the like, and/or one or more of the node C.R.s 716(1)-716(N) can correspond to a virtual machine (VM).

In at least one implementation, grouped computing resources 714 can include separate groupings of node C.R.s 716 housed within one or more racks (not shown), or many racks housed in data centers at various geographical locations (also not shown). Separate groupings of node C.R.s 716 within grouped computing resources 714 can include grouped compute, network, memory or storage resources that can be configured or allocated to support one or more workloads. In at least one implementation, several node C.R.s 716 including CPUs, GPUs, DPUs, and/or other processors can be grouped within one or more racks to provide compute resources to support one or more workloads. The one or more racks can also include any number of power modules, cooling modules, and/or network switches, in any combination.

The resource orchestrator 712 can configure or otherwise control one or more node C.R.s 716(1)-716(N) and/or grouped computing resources 714. In at least one implementation, resource orchestrator 712 can include a software design infrastructure (SDI) management entity for the data center 700. The resource orchestrator 712 can include hardware, software, or some combination thereof.

In at least one implementation, as shown in FIG. 7, framework layer 720 can include a job scheduler 728, a configuration manager 734, a resource manager 736, and/or a distributed file system 738. The framework layer 720 can include a framework to support software 732 of software layer 730 and/or one or more application(s) 742 of application layer 740. The software 732 or application(s) 742 can respectively include web-based service software or applications, such as those provided by Amazon Web Services, Google Cloud and Microsoft Azure. The framework layer 720 can be, but is not limited to, a type of free and open-source software web application framework such as Apache Spark™ (hereinafter “Spark”) that can use distributed file system 738 for large-scale data processing (e.g., “big data”). In at least one implementation, job scheduler 728 can include a Spark driver to facilitate scheduling of workloads supported by various layers of data center 700. The configuration manager 734 can be capable of configuring different layers such as software layer 730 and framework layer 720 including Spark and distributed file system 738 for supporting large-scale data processing. The resource manager 736 can be capable of managing clustered or grouped computing resources mapped to or allocated for support of distributed file system 738 and job scheduler 728. In at least one implementation, clustered or grouped computing resources can include grouped computing resource 714 at data center infrastructure layer 710. The resource manager 736 can coordinate with resource orchestrator 712 to manage these mapped or allocated computing resources.

In at least one implementation, software 732 included in software layer 730 can include software used by at least portions of node C.R.s 716(1)-716(N), grouped computing resources 714, and/or distributed file system 738 of framework layer 720. One or more types of software can include, but are not limited to, Internet web page search software, e-mail virus scan software, database software, and streaming video content software.

In at least one implementation, application(s) 742 included in application layer 740 can include one or more types of applications used by at least portions of node C.R.s 716(1)-716(N), grouped computing resources 714, and/or distributed file system 738 of framework layer 720. One or more types of applications can include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more implementations.

In at least one implementation, any of configuration manager 734, resource manager 736, and resource orchestrator 712 can implement any number and type of self-modifying actions based on any amount and type of data acquired in any technically feasible fashion. Self-modifying actions can relieve a data center operator of data center 700 from making possibly bad configuration decisions and possibly avoiding underutilized and/or poor performing portions of a data center.

The data center 700 can include tools, services, software or other resources to train one or more machine learning models or predict or infer information using one or more machine learning models according to one or more implementations described herein. For example, a machine learning model(s) can be trained by calculating weight parameters according to a neural network architecture using software and/or computing resources described above with respect to the data center 700. In at least one implementation, trained or deployed machine learning models corresponding to one or more neural networks can be used to infer or predict information using resources described above with respect to the data center 700 by using weight parameters calculated through one or more training techniques, such as but not limited to those described herein.

In at least one implementation, the data center 700 can use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above can be configured as a service to allow users to train or performing inferencing of information, such as image recognition, speech recognition, or other artificial intelligence services.

### Example Network Environments

Network environments suitable for use in implementing implementations of the disclosure can include one or more client devices, servers, network attached storage (NAS), other backend devices, and/or other device types. The client devices, servers, and/or other device types (e.g., each device) can be implemented on one or more instances of the computing device(s) 600 of FIG. 6—e.g., each device can include similar components, features, and/or functionality of the computing device(s) 600. In addition, where backend devices (e.g., servers, NAS, etc.) are implemented, the backend devices can be included as part of a data center 700, an example of which is described in more detail herein with respect to FIG. 7.

Components of a network environment can communicate with each other via a network(s), which can be wired, wireless, or both. The network can include multiple networks, or a network of networks. By way of example, the network can include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) can provide wireless connectivity.

Compatible network environments can include one or more peer-to-peer network environments—in which case a server cannot be included in a network environment—and one or more client-server network environments—in which case one or more servers can be included in a network environment. In peer-to-peer network environments, functionality described herein with respect to a server(s) can be implemented on any number of client devices.

In at least one implementation, a network environment can include one or more cloud-based network environments, a distributed computing environment, a combination thereof, etc. A cloud-based network environment can include a framework layer, a job scheduler, a resource manager, and a distributed file system implemented on one or more of servers, which can include one or more core network servers and/or edge servers. A framework layer can include a framework to support software of a software layer and/or one or more application(s) of an application layer. The software or application(s) can respectively include web-based service software or applications. In implementations, one or more of the client devices can use the web-based service software or applications (e.g., by accessing the service software and/or applications via one or more application programming interfaces (APIs)). The framework layer can be, but is not limited to, a type of free and open-source software web application framework such as that can use a distributed file system for large-scale data processing (e.g., “big data”).

A cloud-based network environment can provide cloud computing and/or cloud storage that carries out any combination of computing and/or data storage functions described herein (or one or more portions thereof). Any of these various functions can be distributed over multiple locations from central or core servers (e.g., of one or more data centers that can be distributed across a state, a region, a country, the globe, etc.). If a connection to a user (e.g., a client device) is relatively close to an edge server(s), a core server(s) can designate at least a portion of the functionality to the edge server(s). A cloud-based network environment can be private (e.g., limited to a single organization), can be public (e.g., available to many organizations), and/or a combination thereof (e.g., a hybrid cloud environment).

The client device(s) can include at least some of the components, features, and functionality of the example computing device(s) 600 described herein with respect to FIG. 6. By way of example and not limitation, a client device can be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure can be practiced in a variety of system configurations, including hand-held devices, consumer electronics, general-purpose computers, more specialty computing devices, etc. The disclosure can also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” can include only element A, only element B, only element C, element A and element B, element A and element C, element B and element C, or elements A, B, and C. In addition, “at least one of element A or element B” can include at least one of element A, at least one of element B, or at least one of element A and at least one of element B. Further, “at least one of element A and element B” can include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

What is claimed is:

1. A system, comprising:
one or more processors to:
obtain, from at least one data source, a plurality of content records corresponding with at least one content source of the at least one data source;
determine a subset of a plurality of embeddings corresponding to at least one category, wherein determining the subset of the plurality of embeddings is based at least on a ranking of the plurality of embeddings organized according to the at least one category;
apply the subset of the plurality of embeddings as input to at least one language model (LM) to cause the at least one LM to generate a plurality of modified content and corresponding metadata;
generate, using the plurality of modified content and the corresponding metadata, at least one output based at least on a template; and
provide, via an interface, the at least one output.

2. The system of claim 1, wherein the one or more processors are to:
generate, using at least one second LM, the template based at least on at least one schema or at least one structure parameter corresponding with organizing the plurality of modified content and the corresponding metadata.

3. The system of claim 1, wherein the one or more processors are to:
update the plurality of content records based at least on at least one of:
a similarity threshold between at least two of the plurality of content records; or
identifying attributes in the plurality of content records.

4. The system of claim 3, wherein the one or more processors are to:
generate, using the plurality of embeddings corresponding with the plurality of content records and a plurality of structured outputs, a plurality of clusters based on at least one similarity metric; and
apply the plurality of clusters as input to at least one third LM to cause the at least one third LM to generate at least one cluster representation.

5. The system of claim 4, wherein the one or more processors are to:
obtain additional content corresponding to the at least one cluster representation based on interfacing with a plurality of data sources;
update the at least one cluster representation corresponding to at least one trend identified in the additional content;
update a ranking function based on the at least one updated cluster representation, the ranking function used in the ranking of the plurality of embeddings; and
update the at least one output based at least on the at least one updated cluster representation, wherein updating the at least one output comprises at least one of:
incorporating at least one summary of the additional content into the at least one output; or
updating the corresponding metadata.

6. The system of claim 1, wherein the one or more processors are to:
generate, using a curation model, the plurality of embeddings of at least one segment of the plurality of content records based on at least one of:
at least one textual element;
at least one contextual attribute; or
metadata of the plurality of content records.

7. The system of claim 6, wherein the one or more processors are to:
receive, from a user device, a query corresponding to at least one of a plurality of outputs;
generate an embedding of the query;
determine, based at least on the embedding, a filtered subset of the plurality of embeddings;
apply the filtered subset of the plurality of embeddings as input to the at least one LM to cause the at least one LM to generate a response to the query; and
provide, to the user device, the response to the query.

8. The system of claim 1, wherein the one or more processors are to:
obtain a conversation cache and historical conversation data based at least on interfacing with a plurality of data sources;
generate, using the conversation cache and the historical conversation data, a plurality of clusters based at least on a preference similarity metric;
apply the plurality of clusters as input to at least one fourth LM to cause the at least one fourth LM to generate at least one cluster representation; and
update a ranking function based on the at least one cluster representation, the ranking function used in the ranking of the plurality of embeddings.

9. The system of claim 1, wherein the at least one content source corresponds to a set of identifiers of at least one data source identified based at least on user activity data or a similarity metric to the at least one category, and wherein determining the subset of a plurality of embeddings is based on at least on using a fifth LM to process a plurality of relationships between the plurality of embeddings and the at least one category.

10. The system of claim 1, wherein the system comprises an agent computing system to obtain and model structured and unstructured data, and wherein the at least one data source comprises a first data source accessed via a first data channel and a second data source accessed via a second data channel.

11. The system of claim 1, wherein the system is comprised in at least one of:
a system for generating one or more structured outputs;
a system for aggregating or summarizing one or more content records based on one or more categories or one or more trends;
a system for selecting one or more content records for presentation;
a system for generating one or more personalized outputs;
a system implementing one or more multi-model language models;
a system implementing one or more large language models (LLMs);
a system implementing one or more small language models (SLMs);
a system implementing one or more vision language models (VLMs);
a system for generating synthetic data;
a system for generating synthetic data using AI;
a control system for an autonomous or semi-autonomous machine;
a perception system for an autonomous or semi-autonomous machine;
a system for performing digital twin operations;
a system for performing light transport simulation;
a system for performing remote operations;
a system implemented using an edge device;
a system implemented using a robot;
a system for performing conversational AI operations;
a system incorporating one or more virtual machines (VMs);
a system for using or deploying one or more inference microservices;
a system for presenting at least one of virtual reality content, augmented reality content, or mixed reality content;
a system implemented at least partially in a data center; or
a system implemented at least partially using cloud computing resources.

12. One or more processors comprising processing circuitry to:
obtain, from at least one data source, a plurality of content assets corresponding with the at least one data source;
determine a subset of a plurality of embeddings corresponding to at least one category, wherein determining the subset of the plurality of embeddings is based at least on a ranking of the plurality of embeddings organized according to the at least one category;
apply the subset of the plurality of embeddings as input to at least one language model (LM) to cause the at least one LM to generate, using a template, at least one output comprising a plurality of modified content and corresponding metadata; and
provide, via an interface, the at least one output.

13. The one or more processors of claim 12, wherein the processing circuitry is to:
generate, using at least one second LM, the template based at least on at least one schema or at least one structure parameter corresponding with organizing the plurality of modified content and the corresponding metadata.

14. The one or more processors of claim 12, wherein the processing circuitry is to:
update the plurality of content assets based at least on at least one of:
a similarity threshold between at least two of the plurality of content assets; or
identifying attributes in the plurality of content assets.

15. The one or more processors of claim 14, wherein the processing circuitry is to:
obtain the plurality of embeddings corresponding with the plurality of content assets and a plurality of structure outputs;
generate, using the plurality of embeddings, a plurality of clusters based on at least one similarity metric; and
apply the plurality of clusters as input to at least one third LM to cause the at least one third LM to generate at least one cluster representation.

16. The one or more processors of claim 15, wherein the processing circuitry is to:
obtain additional content corresponding to the at least one cluster representation based on interfacing with a plurality of data sources;
update the at least one cluster representation corresponding to at least one trend identified in the additional content;
update a ranking function based on the at least one updated cluster representation, the ranking function used in the ranking of the plurality of embeddings; and
update the at least one output based at least on the at least one updated cluster representation, wherein updating the at least one output comprises at least one of:
incorporating at least one summary of the additional content into the at least one output; or
updating the corresponding metadata.

17. The one or more processors of claim 12, wherein the processing circuitry is to:
generate, using a curation model, the plurality of embeddings of at least one segment of the plurality of content assets based on at least one of:
at least one textual element;
at least one contextual attribute; or
metadata of the plurality of content assets.

18. The one or more processors of claim 17, wherein the processing circuitry is to:
receive, from a user device, a query corresponding to at least one of a plurality of outputs;
generate an embedding of the query;
determine, based at least on the embedding, a filtered subset of the plurality of embeddings;
apply the filtered subset of the plurality of embeddings as input to the at least one LM to cause the at least one LM to generate a response to the query; and
provide, to the user device, the response to the query.

19. The one or more processors of claim 12, wherein the processing circuitry is to:
obtain a conversation cache and historical conversation data based on interfacing with a plurality of data sources;
generate, using the conversation cache and the historical conversation data, a plurality of clusters based at least on a preference similarity metric;
apply the plurality of clusters as input to at least one fourth LM to cause the at least one fourth LM to generate at least one cluster representation; and
update a ranking function based on the at least one cluster representation, the ranking function used in the ranking of the plurality of embeddings.

20. A method, comprising:
identifying, by one or more processors from at least one data source, a plurality of content corresponding with the at least one data source;
determining, by the one or more processors, a subset of a plurality of embeddings corresponding to at least one category;
generating, by the one or more processors using at least one language model (LM), at least one output comprising a plurality of modified content and corresponding metadata, the at least one output generated based at least on the subset of the plurality of embeddings; and
causing, using the one or more processors, presentation of the at least one output.
